(19) United States
(12) Patent Application Publication
(10) Pub. No.: US 2014/0219438 A1
(43) Pub. Date: Aug. 7, 2014

(54) SYSTEMS AND METHODS INVOLVING REAL-TIME COMMUNICATIONS PLATFORMS AND/OR PROCESSING

(71) Applicant: RingDNA, Inc., San Francisco, CA (US)

(72) Inventors: Howard Brown, Hidden Hills, CA (US); Kanwar Saluja, San Francisco, CA (US); Todd Bursey, Danville, CA (US); William Tyree, Los Angeles, CA (US); Tao Lin, Palo Alto, CA (US)

(73) Assignee: RingDNA, Inc., San Francisco, CA (US)

(21) Appl. No.: 14/172,873

(22) Filed: Feb. 4, 2014

Related U.S. Application Data
(60) Provisional application No. 61/760,589, filed on Feb. 4, 2013.

(51) Int. Cl. H04M 3/523

(52) U.S. Cl. CPC H04M 3/5235
USPC 379/265.09; 379/265.13

(57) ABSTRACT

Systems and methods are provided for obtaining and providing data about a phone call to a representative. A data repository can be used as transient storage while a phone call is ongoing (and possibly for some time afterwards). Data can be retrieved and stored in the data repository, as well as sent to external systems that a representative might use. A data interface can handle communications between the data repository and the external systems in a controlled manner so that exchanges of particular pieces of data can occur efficiently. A graphical user interface (GUI) can be provided for setting up rules for treating a call. The GUI can provide a convenient interface for specifying a mechanism for exchanging data with an external system. A central control can sent voice, data, and control commands across various channels to various devices when processing an incoming call.

### CROSS-REFERENCE TO RELATED APPLICATION

This application claims priority to and is a non-provisional of U.S. Provisional Patent Application No. 61/760,589, filed Feb. 4, 2013, entitled “SYSTEMS AND METHODS INVOLVING REAL-TIME COMMUNICATIONS PLATFORMS AND/OR PROCESSING,” which is incorporated by reference herein in its entirety.

### BACKGROUND

The present disclosure relates to systems and methods involving real-time communications platforms and/or processing.

Call centers field many calls from customers and potential customers. Often, the customer service or sales representative knows very little about the person calling. And, the call may simply go to the next person available. Thus, systems do not take full advantage of data that can be provided to a representative or used to determine which representative is best suited to take a call. Further, systems usually allow a phone call and perhaps some data to be sent to one dedicated device to a representative, which occurs over an internal system.

Therefore, it is desirable to provide systems and methods that provide greater flexibility in obtaining data related to a phone call and routing that data.

### SUMMARY

Embodiments of the present invention provide systems and methods for obtaining and providing data about a phone call to a representative. In one embodiment, a data repository can be used as transient storage while a phone call is ongoing (and possibly for some time afterwards). Data can be retrieved and stored in the data repository, as well as sent to external systems that a representative might use. A data interface can handle communications between the data repository and the external systems in a controlled manner so that exchanges of particular pieces of data can occur efficiently.

In another embodiment, a graphical user interface (GUI) can be provided for setting up rules for treating a call. The GUI can provide a convenient interface for specifying a mechanism for exchanging data with an external system.

In yet another embodiment, a central control can sent voice, data, and control commands across various channels to various devices when processing an incoming call. The central control can also provide convenient interfaces for making phone calls, e.g., via one's browser.

Other embodiments are directed to systems, portable consumer devices, and computer readable media associated with methods described herein.

A better understanding of the nature and advantages of embodiments of the present invention may be gained with reference to the following detailed description and the accompanying drawings.

### BRIEF DESCRIPTION OF THE DRAWINGS

FIG. 1 is a diagram of a system 100 for handling an incoming call according to embodiments of the present invention.

FIG. 2 is a flowchart of a method 200 for handling an incoming call according to embodiments of the present invention.

FIG. 3 is a flowchart of a method 300 for gathering data according to embodiments of the present invention.

FIG. 4 is a flowchart of a method 400 for gathering data using a repository according to embodiments of the present invention.

FIG. 5 is a diagram of a user interface 500 for provisioning for campaign tracking according to embodiments of the present invention.

FIG. 6 is a diagram of a user interface 600 for call flow prompts according to embodiments of the present invention.

FIG. 7 is a diagram of a user interface 700 for call flow callouts according to embodiments of the present invention.

FIG. 8 is a flowchart of a method 800 for providing a graphical user interface (GUI) for specifying an interface for exchanging data between a call routing system and a first external data source according to embodiments of the present invention according to embodiments of the present invention.

FIG. 9 is a flowchart of a method 900 for routing calls according to embodiments of the present invention.

FIG. 10 is a flowchart of a method 1000 for providing centralized control for processing incoming calls according to embodiments of the present invention.

FIG. 11 is a diagram of a system 1100 for separation of voice and data elements of a call according to embodiments of the present invention.

FIG. 12 is a diagram of a user interface 1200 for providing centralized control of an incoming call according to embodiments of the present invention.

FIG. 13 is a diagram of a user interface 1300 for providing centralized control over the transfer of a call according to embodiments of the present invention.

FIG. 14 is a diagram of a user interface 1400 for providing centralized control of an outgoing call according to embodiments of the present invention.

FIG. 15 is a diagram of a user interface 1500 for integrating a device with a server using a plug-in according to embodiments of the present invention.

FIG. 16 is a diagram of a user interface 1600 for integrating a device with a server using a plug-in according to embodiments of the present invention.

FIG. 17 shows a block diagram of an example computer system 10 usable with system and methods according to embodiments of the present invention.

### DETAILED DESCRIPTION

Embodiments of the present invention provide systems and methods for obtaining and providing data about a phone call to a representative. In various embodiments, a data repository can be used as transient storage while a phone call is ongoing (and possibly for some time afterwards). Data can be retrieved and stored in the data repository, as well as sent to external systems that a representative might use. A data interface can handle communications between the data repository and the external systems in a controlled manner so that exchanges of particular pieces of data can occur efficiently. A graphical user interface (GUI) can be provided for setting up rules for treating a call. The GUI can provide a convenient interface for specifying a mechanism for exchanging data with an external system. And, a central control can sent voice, data, and control commands across various channels to various devices when processing an incoming call. The central control can also provide convenient interfaces for making phone calls, e.g., via one's browser.

Embodiments can also route calls based on data. Embodiments may collect potential information related to the caller including caller activities, product info, marketing analytics data, data from social network and also the performance of each representative based on key categories. This data can be used to route calls.

### I. Incoming Calls

A. System

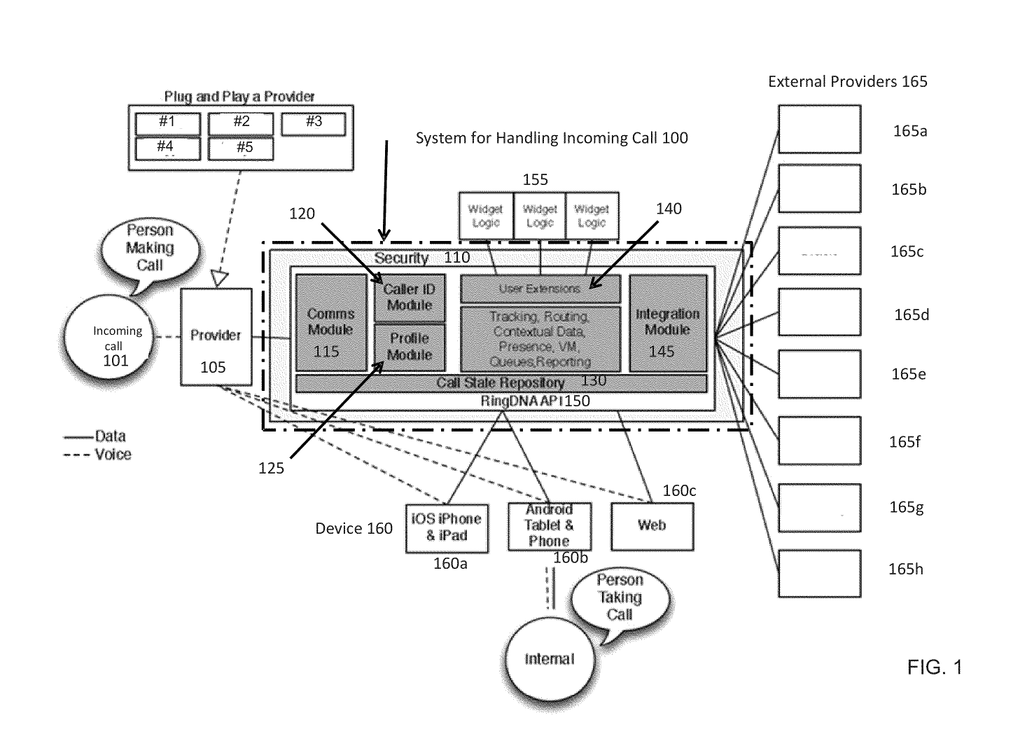

FIG. 1 is a diagram of a system 100 for handling an incoming call according to embodiments of the present invention. System 100 provides the infrastructure to retrieve data from multiple sources and present it to users of system 100 (hereinafter referred to as “users”) in a usable fashion so that they can interact with their customers more effectively.

An incoming call 101 is received by a provider 105. Provider 105 can be any one of multiple telephony providers, which can be over VOIP or include more traditional phone protocols. Provider 105 sends incoming call 101 to a security layer 110. If incoming call 101 meets the security standards set by security layer 110, incoming call 101 is sent to an API 150.

Incoming call 101 is then sent to a communications module 115. In general, communications module 115 instructs provider 105 where to deliver incoming call 101, what call treatment to apply, and what to do with it. Communications module 115 can make a request to provider 105 as to whether provider 105 has any information about the call.

Communications module 115 directs a caller ID module 120 to gather information related to incoming call 101. Caller ID module 120 gathers information from external databases. For example, the calling name, phone number, city, state, zip code, and country may be retrieved from the national caller ID database if they are available. Further information, such as the calling device's MAC (media access control) address, may be gathered from the telephony provider where incoming call 101 originated from, and from other external sources such as Whitepages.com.

The data that is retrieved by caller ID module 120 is dictated by a business service agreement between the administrator of system 100 (hereinafter referred to as the “administrator”) and a user who will eventually be receiving the incoming call 101. The administrator defines different levels of service that include certain sets of external databases from which data will be retrieved; users purchase the desired level of service and the administrator grants the licenses that allow data to be drawn from the external databases included in the purchased level of service. For example, a basic level of service could allow access to the national caller ID database; an intermediate level of service would allow access to the telephony provider's database, and a full level of service would allow access to all other external databases.

Communications module 115 can direct a profile module 125 to gather profile information related to incoming call 101, e.g., from internal or external databases. For example, an internal database may exist, e.g., storing data associated with a phone number. This data can be pulled intransient data store 130. In various embodiments, profile module 125 can gather data such as profile pictures of the caller from social networks, information from news sources, credit reports, etc. The data gathered by profile module 125 may depend on the tier of service ordered by the user, similar to data gathered by caller ID module 120.

Communications (comm) module 115 assigns an ID to incoming call 101, and places the ID in a transient data store 130 (labeled as a data repository). The data gathered by caller ID module 120 and profile module 125 is also placed in transient data store 130 and is associated with the ID. The ID acts as a key for external providers 165 to access transient data store 130 in order to retrieve information related to incoming call 101. Comm module 115 can communicate to data store 130 as to a current step in the process.

Transient data store 130 can be flexible in that it accepts data with undefined elements, though it does support data being categorized or tagged. For example, a caller enters a number as the first step in contacting their bank before they are routed to an agent. Bank A may ask for an “account number,” while Bank B may ask for a “personal number.” Transient data store 130 is flexible enough to store both of these data types regardless of how they are defined. Data store 130 can be unstructured so as to store any amount of data for each call, e.g., using XML or JSON, e.g., with a keys (tags) identifying various data.

External providers 165 with a key access transient data store 130 via the security layer 110 and API 150, and then they can retrieve the data associated with the ID for incoming call 101. Continuing the example above, Bank A may write its own logic such that it can handily consume the data tagged as “account number” that it retrieves from transient data store 130. Throughout this transaction, system 100 does not necessarily need to know what the “account number” data is; rather, it just needs to store the data along with the tags and ID. External providers 165 are labeled as 165a-165h to indicate that system 100 can communicate with many external providers, even during a same phone call. A user can set up system 100 in advance to establish mechanisms (e.g., data names to be passed and a name of data retrieved) for communication with specified external providers 165, as may be provided by a path (e.g., a URL).

To get information from external providers 165, the user defines what the information is; to access this data, function calls or an API must be provided. System 100 passes along the function calls or API similarly to the ID, so that the data may also flow through. System 100 has standards objects and standard data, but users can also write their own widget logic 155 to interpret the data. In various embodiments, widgets and solutions may include, among other features, a campaign, outbound call, inbound call, supporting ticket, maintenance ticket, geo widget, calendar widget, contact widget, dial widget, reporting widget, video widget, notes widget, and a call flow widget.

In some embodiments, external providers 165 can have a loosely or tightly bound integration with transient data store 130. An integration module 145 can be used with the integration. In one embodiment with loosely bound integration, system 100 can notify external provider 165 that it has a new call (e.g., by sending a call ID), but not notify the exact nature of the data. There may be metadata that indicates to external provider 165 what type of data is available, e.g. the transient data store can contain caller ID data, tracking data, contextual presence data, and unidentified data all related to incoming call 101. In one implementation, the external provider 165 can retrieve and analyze the information. For instance, external provider 165 can specifically pull data that is categorized or tagged “name” in order to get the name related to incoming call 101. Internal widget 155 can provide similar functionality for directing integration module 145.

With a tightly bound integration, system 100 can push data from transient data store 130 to external providers 165 using APIs, e.g., without doing any post processing. In that case, system 100 can know how external providers' 165 databases are structured, so that it is apparent what kind of data is to be sent, e.g., specific database calls can be made. For example, a caller's record could be pushed into a CRM system, where the record on system 100 can be save in a manner consistent with the external provider (such instances may have the record stored in an internal database that is separate from data store 130). Incoming call 101 could be linked to a sales campaign; it could include notes, ratings, call durations, etc. In one aspect, this can be possible because an external provider has given system 100 access to push data into the external system.

Integration module 145 can communicate with databases of external providers 165 to provide data to and to gather external data from external providers 165. The communication protocol (all termed a call treatment or call flow) can be define by a user of system 100 in establishing protocols for handling incoming calls. Data gathered from external providers 165 may relate to various variables, metrics, and values, such as tracking, routing, contextual information, presence, voice mail, queues, reporting, etc. Users can plug in their own widget logic 155 to create user extensions 140 that expand beyond the functionality of system 100. For example, widget logic 155 can define how data from an external provider 165 is stored and/or processed for providing to a device 160. System 100 can take certain actions based on this information, such as routing incoming call 101 to a certain destination or device 160, displaying certain data to a call representative taking the call, etc.

Scenarios outlined below demonstrate how implementations of system 100 may be used to handle incoming calls. As an example, a financial services company that is using system 100 can receive a call from one of their customers. The customer enters his account number before being routed to an agent. Integration module 145 retrieves data from external providers 165, such as 165a or 165c, where the gathered data can be specified by specifying keys for a name (tag or key) for data stored in transient data store 130 and a name for the data stored in transient data store 130. The external provider can be programmed to receive certain data and provide a response, where system 100 is configured to provide the data (e.g., along with a name of the data, which may be used to identify which functionality should be used on the external provider). Response data can then be obtained from an external provider 165 and then be stored into transient data store 130, also according to a predefined name. In this manner the same data can be shared between external providers that track the data using different names and data structures.

It may be that the customer dialed a certain phone number that was only displayed on the company's IRA site (see section III-A for details on provisioning phone numbers). Based on this and the data collected from external providers 165 or other sources, it can be known where the caller came from, who he is, etc., and this information can be used to route the call to one of the company's IRA specialists, who may receive a prompt to say “hello [name of customer], thanks for calling. I see that you're looking at our IRA site. Can you just please confirm your mom's maiden name.” The customer then confirms their mom's maiden name, and the company's custom widget logic 155 authorizes the caller to move forward with the conversation.

Consider the case that the caller is transferred to another department. All of the data is in transient data store 130, and the ID is passed along to the second representative; the system would still identify the caller and know that he's been authorized previously and relay this information to the second representative. That second representative can then pick up the call and say “hello [name of customer], I see that you were just talking with my colleague, let's continue that conversation.” The same authorization and data gathering questions do not need to be repeated; all of the data previously gathered will be interpreted, generally by the company's widget logic 155, to continue the flow of the call.

Consider another example of how a user can write their own logic to take advantage of the infrastructure of system 100, in continuation of the above scenarios. During the call to the IRA line of the company, the company may retrieve information from an external provider 165 financial system such as 165d, to determine whether the caller owes money to the company. This information could then be relayed to the agent handling the call, or it could be used in compiling an outbound call list for another agent who is in charge of debt collection. Thus, the data received from one external provider can also be sent to another external provider, where response data can be obtained from both.

B. Method

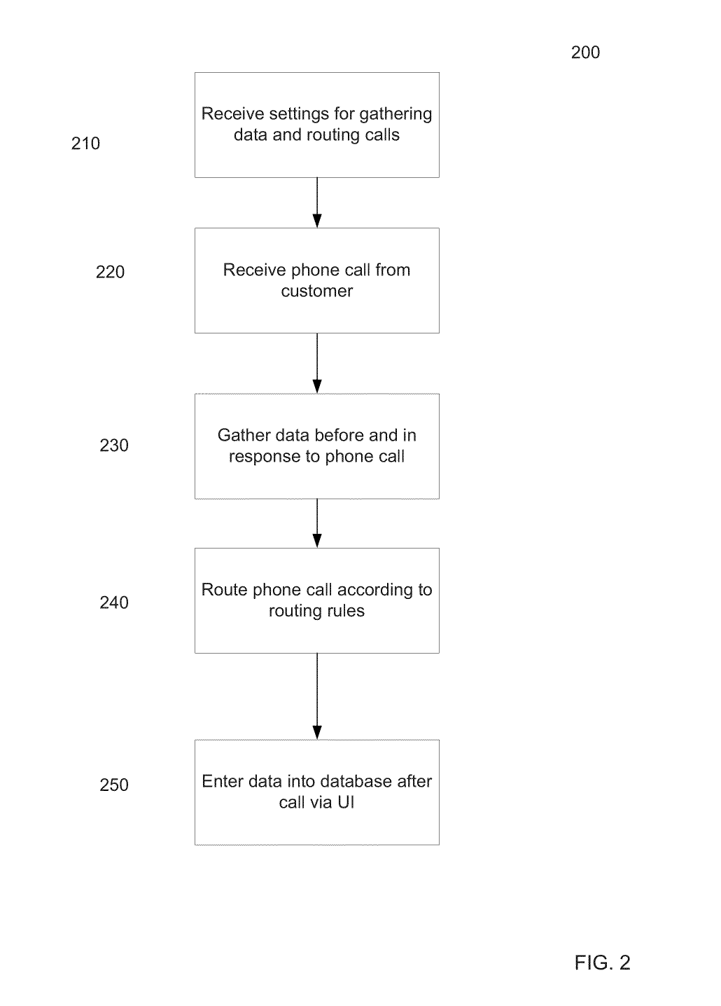

FIG. 2 is a flowchart of a method 200 for handling an incoming call according to embodiments of the present invention. Method 200 may be performed by a computer system, e.g., system 100.

At block 210, settings for gathering data and routing calls are received. These settings are defined by the level of service the user is signed up for, as well as by routing logic of method 200 and routing logic written by the user. See Section I-A for further information on tiered service and section IV-A for further information on routing.

At block 220, a call is received from the customer. The call may be received from a telephony provider, as described above. The call may be analyzed or more information may be requested from a provider. The information about the call can be saved (e.g., in a data store) and used for gathering more data. A communications module can determine how to process the call according to a call treatment, which can include data gathering rules.

At block 230, data is gathered before and in response to the phone call. Data gathering can be implemented by a caller ID module, a profile module, and an integration module. For example, a phone number of the person calling can be used to obtain further information from internal and external databases. Certain databases can have predetermined APIs for requesting data, e.g., publicly available databases can have published queries from subscribers to obtain data. Other external data can be obtained from data that is not publicly available, but corresponds to data managed by a user (e.g., a company operating a call center) on an external system, e.g., a CRM database. Further details are provided in Section II for further information on gathering data, and Section I-A for further information on data gathering in the context of handling incoming calls.

At block 240, the call is routed according to the routing rules that were defined at block 210. See section IV-A for further information on call routing, and section I-A for further information on call routing in the context of handling incoming calls.

Certain embodiments include a logic-based routing engine. The routing engine receives and analyzes certain incoming customer data, such as the customer's previous call history, current location, social media details, internet cookie information, or calling device's MAC (media access control) address. The routing engine also receives and analyzes certain contextual data, such as available representative expertise, network activity, business needs, and other factors. Based on its analysis of the incoming data, the routing engine selects which representative should respond to the call.

At block 250, data can be entered into a database after the phone call via a user interface (UI). For example, the caller representative who was on the call may enter information related to the call (such as call date, subject, and outcome) into a CRM system via a UI. As another example, a user can add to a CRM entry through manual input; for example, following the conclusion of a call, the user can “rate” the success of the call by choosing one to five stars on a screen displayed by the system, which then inputs the rating into a linked CRM database.

In another embodiment, data may also be entered automatically. For example, predefined settings can be se to store data with certain tags. The logic can be dynamic in that certain tags might not exist, and thus such data could not be stored. And, the storing of some data might be dependent on whether other data exists. Further, embodiments may be configured to select data from the data store, identify the information that is meaningful to decision makers, and integrate it with a system (internal or external) that can be used to report on metrics such as sales representative performance.

### II. Gathering Data

As described above, data can be gather from many sources. And, the data can be pulled from a transient data store and used to gather more data, and response data can be added to the data store. Various techniques can be used for retrieving and adding data to the data store.

A. General Data Gathering

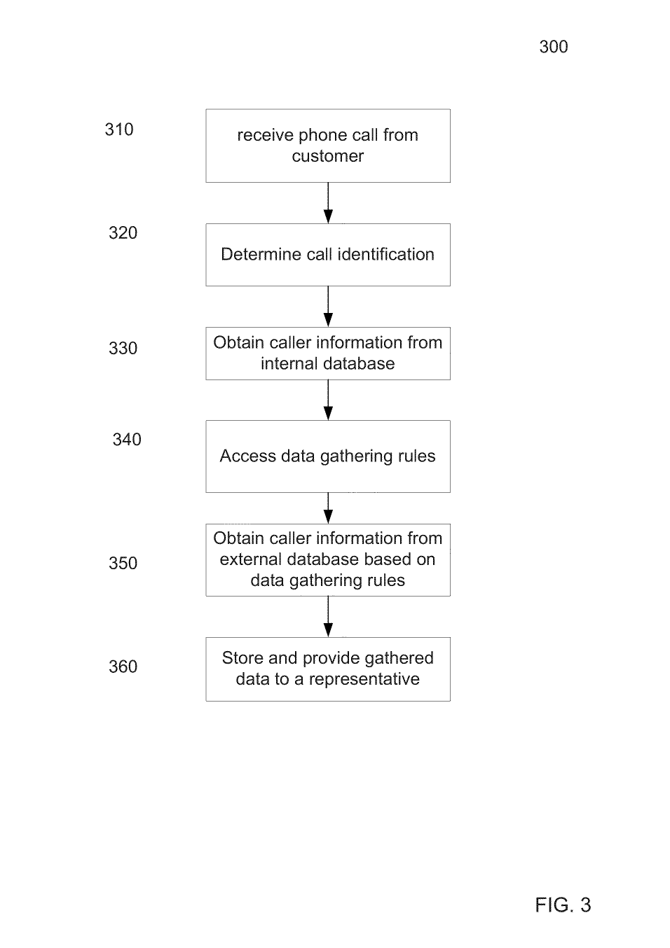

FIG. 3 is a flowchart of a method 300 for gathering data according to embodiments of the present invention. Certain steps of method 300 can be optional, as with other methods described herein.

At block 310, a call is received from a customer. The call may be received from a telephony provider and further data can be requested from the provider, as described above.

At block 320, an identification (e.g., a phone number) of the caller is determined, e.g., as obtained from the provider. Additional information can be obtained from the provider, such as a name, location of the number, etc.

At block 330, caller information may be obtained from an internal database. For example, data regarding the call may be cross-checked against other call data that exists in the internal database to look for matches or similarities; proximity or match-based techniques may be used to associate data from the internal database with the call. Data may already exist when the person has called before. The data may also be gathered from an external database, e.g., when the user keeps the data stored in a CRM system that is external to a routing system. The data obtained can be stored in a transient data store, as described herein.

At block 340, data gathering rules are accessed. These rules can be defined by the level of service the user is signed up for; for example, if the user has signed up for an entry level of service, the data gather rules may say that only basic caller ID data (e.g. name and geographic location) is to be gathered for the call. Data gathering rules dictate what data to look for, and when and where to look for it. For example, data gathering rules may say that data is to be taken from a certain social media website associated with the caller at one-minute intervals during the call. See Section I-A for further information on tiered service and how it relates to data gathering rules.

Parts of the data gathering rules can be specified by widget logic written by the user. The user can also specify the data gathering rules via a user interface (UI). The data gathering rules can be accessed by a variety of modules. In one embodiment, comms module 115 can store the data gathering rules as part of a call treatment that defines how a call is processed.

At block 350, caller information is obtained from external databases based on the data gathering rules described above. For example, a known and preprogrammed API of a public database can be used to query the database and obtain pre-defined pieces of data as defined in the API. As another example, the data gathering rules can include integration rules that are defined by a user. For example, a user can specify a path for sending a message that includes key names for data to be passed to an external provider (e.g., keys internal to the routing system and keys used by the external provider) and a key for storing response data. As the user may have an account with the external provider, the user can add logic to the external provider's system for handling such messages from a routing system.

In one embodiment, data gathering rules can specify what data to look for, and when and where to look for it. For example, data gathering rules may specify that data is to be taken from a certain social media website associated with the caller at one-minute intervals during the call.

At block 360, the gather data can be stored (e.g., in a transient data store) and provided to a representative, e.g., a representative to which the call is routed or later transferred. Thus, this information may be displayed to an agent, entered into a database manually or automatically, and used for routing and other purposes. See Sections I-A and III-B for further information on how gathered data may be used.

B. Repository

Implementations may utilize a repository (transient data store 130 in FIG. 1) to store data on a temporary basis. Data that is gathered by the caller ID module, profile module, and integration module may be stored in the transient data store for a limited period of time, e.g., dictated by the memory limitations of the transient data store. Thus, the data store can be transient in that data is kept for a limited amount of time, e.g., until a maximum storage level is met, or after a specified amount of time.

In one embodiment, transient data store is kept in memory (e.g., in RAM) so that data can be accessed quickly. Metadata can be included in data store 130 so that each piece of data can have a tag (key) that categorizes the type of data. The tags can include sub-categories of categories, e.g., some tags can be more specific than others.

In another implementation, a permanent storage could be used, but such a store might require a high amount of storage. If such data is desired to be kept, it can be offloaded to a permanent storage, as may be done after the end of a call. In one embodiment, an administrator can have the capability to check a flag within the system for data in the transient data store that will move the data into a non-transient data store, i.e. to save it in a more permanent sense than if it were to only exist in the transient data store.

When a call is received, an ID can be created for the call. This call can then be used to create an entry in the data store. Data that is placed in the transient data store is associated with the call ID that has been assigned to a call. The ID can be used to retrieve data for the call. A request to retrieve data can include specific keys (tags) to obtain any data stored with the specified key. The keys can be used to obtain data for sending to an external provider as part of a call treatment, and potentially for responding to requests received from an external provider. Thus, a user who uses a service by an external provider can have that external provider pull in any data that is contextual to them and then prioritize that data in a way that is relevant for a particular sales representative.

The transient data store may be flexible in that it can accept data with undefined elements, though it may support data being categorized or tagged. For example, a caller can enter a number as the first step in contacting their bank before they are routed to an agent. Bank A (a user) may ask for an “account number,” while Bank B (also a user) may ask for a “personal number.” The transient data store is flexible enough to store both of these data types regardless of how they are defined. Note that different users can use different systems and different data stores (or the same data store, which can handle call treatments from multiple users, where security is handled by knowing the user for each entry in the data store).

The data and a corresponding tag can be stored for each piece of data, thereby allowing any amount of data. Thus, the transient data store does not need to know what the data is or how it is structured in order to save it in the transient data store; rather, it is up to the external providers and users to define their own logic on how to deal with the data so that it can be consumed. Since the storage can be unstructured, a user can put as much information as is desired for an entry corresponding to the call. A specific piece of data can be retrieved using a key, which is used to retrieve any data having that key. The data store can be search sequentially to identify one or more pieces of data with the corresponding key.

The data store can include metadata that specifies general types of data stored. This metadata would not be on a data by data basis, but specify whether any data exists within a broad category. The specific types of data can be obtained by analyzing the tags in the data store. This general metadata can be obtained independently of the tags.

C. Method (Using Repository)

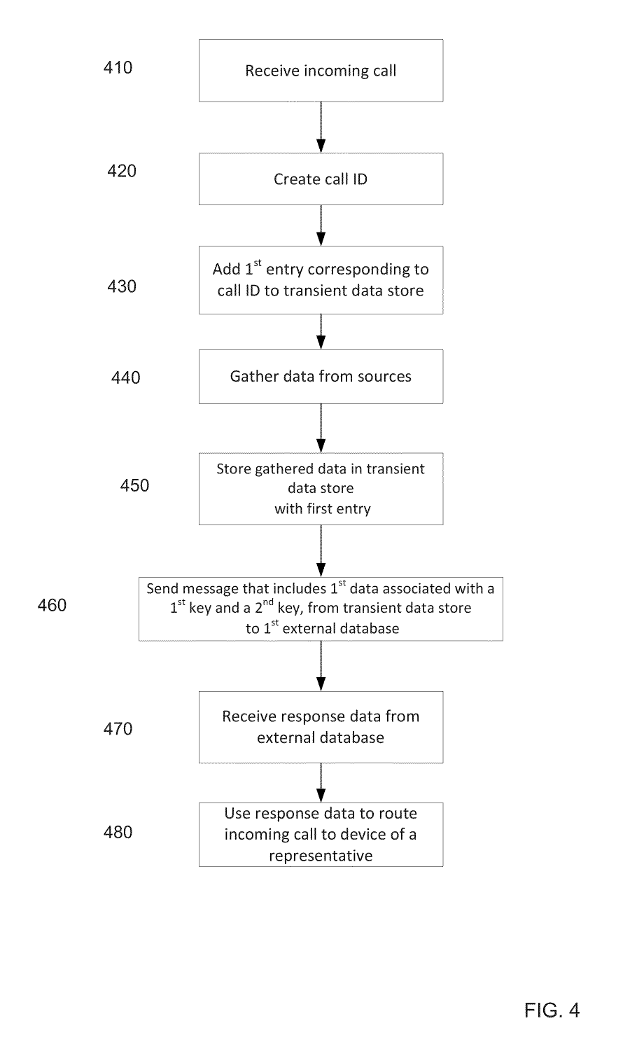

FIG. 4 is a flowchart of a method 400 for gathering data using a repository according to embodiments of the present invention.

At block 410, an incoming call is received, e.g., at a communications module of a system. Further details are provided in other sections.

At block 420, a call ID is created for the incoming call. A unique call ID can be assigned to every call that is received by the system, which can occur regardless of whether the call originates from the same source. The call ID can act as an association that links the call to any data related to the call, whether the data is gathered from internal and external databases. The call ID can also be used as a key for downstream users to access the data in the transient data store that associated with the call ID.

At block 430, a first entry corresponding to the call identification of the incoming call is added to a transient data store of the system. The call ID can be stored in the transient data store at the beginning of the entry. The call ID can have a structure or a key associated with it, so as to identify the data as the call ID, and potentially to separate different entries.

At block 440, data may be gathered from one or more data sources according to one or more data gathering rules. The data may be obtained from internal or external data sources, such as public databases storing data associated with phone numbers. For example, caller ID module 120 or profile module 125 can be used to obtain data. See Section II-A and other sections for more information regarding data gathering.

At block 450, the gathered data is stored in the first entry of the transient data store. The gather data can be stored after a beginning of the first entry so that the data is associated with the call ID. The gathered data can be stored with keys identifying different pieces of data. For instance, the caller's name may have been retrieved from an external database; the name data would be stored along with a key or tag that identified the data as “name.” The identifying key/tag can be used so that downstream users of the system can write code to consume the data.

At block 460, a message is sent from the transient data store to a first external system. This external database could belong to a SEM, CRM, financial provider, etc. The message can include first data of the first entry according to a call out rule that specifies a first key corresponding to the first data, where the first data is stored in the transient data store associated with the first key. The message can also include a second key that is associated with the first data at the first external data source.

The first data can be any data in the data store. An external system can use the first data in any way, e.g., as may be programmed by a user of the routing system. For example, the first data can be used to determine whether the caller is an existing customer, who their personal sales representative is, etc. The first key may identify what the first data is to the routing system, and the second key can identify what the first data is to the first external system.

At block 470, response data in response to the message is received from the first external database. A third key can be used to save the response data in the transient data store. For example, the third key can specify where to route the call (which can be saved as the current person assigned to the call), which data to send to a rep, information about past calls by the customer, etc.

At block 480, the response data is used in routing the incoming call to a device of a representative. For instance, a widget can be used to interpret the data for routing. For example, if the caller called a phone number that is associated with a web page far along in the purchasing process, the widget logic can route the call to a representative who has a good track record of closing sales. In this example, the location in the calling process can be the response data. In other examples, the response data can specify the person to route the call. As another example, the data can simply be sent along to the assigned rep, and this the response data is used in routing since the data is sent to the rep.

D. Types of Data

Data gathered by implementations can be of any type, given the flexible nature of the transient data store. Because the transient data store does not need to recognize what type of data it is receiving, the data can be structured, unstructured, tagged, not tagged, categorized, uncategorized, etc. The data just needs to be associated with a call ID so that implementations can send it to the correct recipients. It is up to external providers and users to define their own logic on how to deal with the data so that it can be consumed in a useful way.

Data from the internal database may include, but is not limited to, previously-collected information related to the caller's activities, social network data, call history, internet cookie information, and contextual data such as available representatives, network activity, business needs, and caller representative profiles (e.g. experience, position, areas of expertise, etc.). For example, information related to the caller's order history could have been previously collected and stored in the internal database

Retrieved data from the external data source(s) may include, but is not limited to, information related to the caller's activities, social network data, internet cookie information, etc. For example, information related to the caller's shopping habits may be available on a publicly available social media page associated with the caller; data related to those shopping habits can be retrieved from the social media site by the data gathering module.

Embodiments may be configured to receive data from existing enterprise applications (hereinafter, “static data”), as well as data from social networks, marketing analytics, and other traditionally dynamic sources (hereinafter, “dynamic data”). Certain embodiments may then aggregate such static and dynamic data and analyze the combination to make certain decisions. These processes may occur at any time. For instance, the system may be configured to gather, aggregate, and analyze static and dynamic data at pre-determined intervals, or at a certain time of day, or continuously. The data may be gathered before a phone call arrives, e.g., when a customer has made a previous phone call and in the interim.

Gathered data can include real-time communication metrics, marketing metrics and agent performance metrics, may be made available in a wide variety of reports and dashboards with value for many different decision makers within an organization. The data may be provided via a routing system or via an external provider, under direction from a routing system. For example, a company buying TV ads can monitor inbound communications from the television ad, and can adjust spend and ramp agents up or down based on real-time response, lead quality measurements, overall ROI on marketing effort from offline channels, and other data points.

Information based on the interaction with the caller may be collected during the call and a talking script and related information may be provided to the caller representative. Steps leading up to the call (e.g., which web page a user was on, which may be conveyed by a provisioned phone number) can also be obtained.

Implementations may be configured to analyze the stream of information associated with an interaction, filter out the low value data, and present meaningful data to the user at the time it will have maximum value. Some embodiments of the system have the ability to share data among users, giving them the benefits of a unified data set, tailored for user-specific needs. Sections below discuss how data can be transferred to different devices and applications.

Additionally, data about interactions can be stored and used for analysis. For instance, embodiments can push sales closing data captured from an interaction to marketers in real-time, enabling the marketers to quickly see exactly which marketing channels are working and adjust their ad-spend budgeting accordingly.

E. Saving Data

Data that is gathered by the caller ID module, profile module, and integration module may be saved to the transient data store by default. The life of this data is not permanent; the transient data store only has limited memory and pushes out the oldest data when full to make room for new data. Therefore administrators have the capability to check a flag within the system for data in the transient data store that will move the data into a non-transient data store, i.e. to save it in a more permanent sense than if it were to only exist in the transient data store.

Data collected during a call may be saved and stored for later use for a variety of purposes. For instance, customer-related information may be saved for improved customer service when the customer calls again. Caller representative-related information may also be saved, for tracking performance, closing rates, etc.

### III. UI for Setting Call Flows

Users may manipulate implementations' system configurations via streamlined user interfaces (UIs). Such UIs may feature drag-and-drop functionality, among other features, to allow users to easily configure implementation operations. For example, the user can move a holding caller at the bottom of the call queue list up to the top of the call queue list, through a simple mouse action, swipe of the finger, or other action.

Such UIs may be output on web-based platforms, electronic tablets, smartphones, and other devices, allowing for convenient and broad-based user access, at the office and on the go. Embodiments can make use of a graphic user interface (GUI) to present information to the user. User interactions are also done through the GUI. Thus, a user can use a GUI to specify rules for gathering data, as well as other functions.

A. Provisioning Numbers

Embodiments allow users to set up “smart” phone numbers to assist in logic-based routing. A smart number can be provisioned by the system, can be local or toll-free, and can be used over IP telephony to track call origin data, associate with CRM records, assist in communications routing, and other characteristics that may improve business performance. Users can assign to a certain application one of a plurality of phone numbers assigned to the user. The phone numbers being dialed can also be provisioned, e.g., so that a phone number is tied to other data, such as a stage in a shopping process.

Implementations can dynamically provision phone numbers, which can be used for tracking, routing, call flow, and other purposes. The provisioned phone numbers can be local or toll-free, and can be used over IP telephony. Consider the following example that outlines assigning different numbers to different applications.

Phone numbers may be dynamically provisioned to different areas of a marketing campaign: a company website, a piece of offline collateral, a billboard, web search, etc. All of those individual pieces may be mapped to an individual phone number so that when someone calls it is known that the phone number they're calling from is attached to the corresponding campaign source.

For example, a user may choose to assign a certain phone number to be displayed in the user's advertisements on social networks, a second phone number to be displayed in the user's print advertisements, a third phone number to be displayed in the user's search engine advertisements, and so on.

Phone numbers may also be dynamically provisioned to search keywords. For example, a person makes a web search for a company that includes a certain keyword, and the company's webpage that is linked to in the search results may display a phone number that is dynamically provisioned according to the keyword that was searched for. Embodiments may be integrated with SEM programs, e.g., which are used to advertise on a search engine and track results using analytics.

As an example, when someone types in a keyword that is tied to a provisioned phone number (i.e., the phone number can change based on the keyword), that phone number can act as a tracking cookie for that person. This can become campaign data which in the back end can do things like provide the cost for that phone call. On the front end it can present a script to an agent, so that agent knows what to talk about. It can be appended with other information, for instance caller identification data that reveals the person is already a customer in the CRM database, so the call should be routed to their sales rep who they have a relationship with.

The dynamically provisioned phone number can be based on other things as well, such as product types, stage of buying cycle, etc. For instance, different phone numbers could be provisioned depending on whether the person is looking at a company's printers or hard drives. Or, different phone numbers could be provisioned such that a person who is looking at printers after searching for them is displayed a phone number for a junior representative, while a person who is at a printer comparison page is further down the buying funnel and will thus be displayed the phone number of a more seasoned representative.

Logic that is used with dynamically provisioned phone numbers can allow users to dynamically route calls to the best available representative, which does not have to be a static result; if a representative's performance goes up, the routing logic can track that. The same can be done for the information that is displayed to the representative; as the data changes, the logic may also modify what is displayed. By assigning different numbers to different applications, not only can embodiments intelligently route phone calls to specific representatives based on the phone number called, but the user can gain insight into the sources that lead to the calls.

Based on the phone number or other piece of identification gathered, certain caller information could be obtained. Caller information could be associated with a certain campaign source: it could be from a company website, a piece of offline collateral, a billboard, etc. All of those individual pieces may be mapped to an individual phone number so that when someone calls it is known that the phone number they are calling from is attached to a campaign source.

For example, someone may use a search engine with a a search term that landed them in a group of search results. The user clicks on a search result which is then going to land them on a particular page on a site. That page corresponds to a campaign or keyword and that campaign or keyword has matched inside of a database, e.g., as provided by an external system or an internal database. As another example, the phone number can be assigned to a support page, and this would be known based on the provisioning of the number.

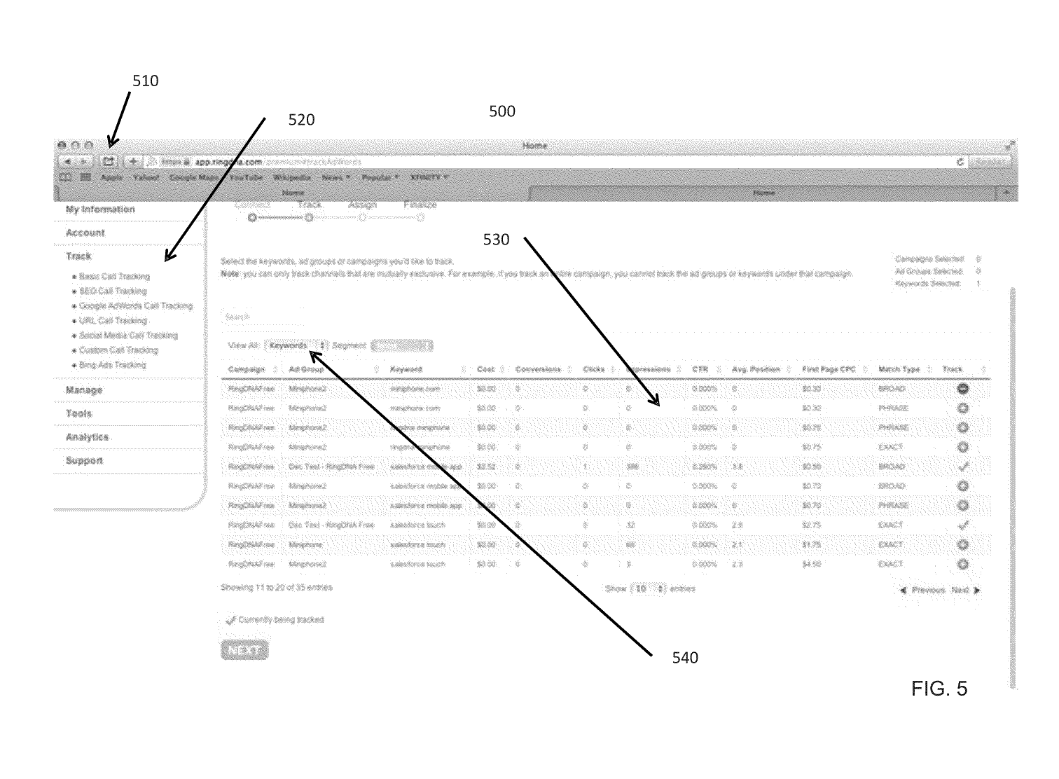

FIG. 5 is a diagram of a user interface 500 for provisioning for campaign tracking according to embodiments of the present invention. The tracking may be set on the user's mobile device, tablet, or from the web using an internet browser 510. Users can navigate among different categories and subcategories as shown in area 520. Here, the user can select options that will bring them to web pages where they can view their profile information, account information, tracking tools, management tools, tools, analytics, and support.

Depending on the option that is selected, content will be shown in area 530; in this case ad campaign tracking information is shown. Various options may be available to filter the information, e.g. dropdown menu 540 allows the user to view campaigns by keywords (selected) or other selections.

In the example shown in 500, the user has linked an implementation to the user's search advertising account (implementations may be linked to other SEM services as well). The implementation receives data from a database based on the link that has been established. User interface 500 displays data related to keyword tracking, but other implementations can also display data related to URL tracking, social media, custom call tracking, etc. The user can make selections on user interface 500 to provision phone numbers against certain keywords and choose free or local numbers. This is the way that a user sets up the link that says that when a certain keyword is searched, a dynamically provisioned phone number will be deployed.

Thus, a phone number can be provisioned and linked to a sales campaign managed by a CRM system, which can give permission to the implementation to push data to its databases. The user can link the provisioned phone number to the CRm system so that when the number is called, the CRM interface is shown and data about the call may be entered manually or automatically. The user could also link the provisioned phone number to, for example, a call script directing an agent on what to say; the call script would appear on the agent's screen when they receive the call.

Area 530 shows keywords that are being tracked. These numbers can be assigned, e.g., by selecting a keyword and providing a number. Once a number has been assigned, a snippet of code can be added to a destination URL so that the system can interact with the data source. The code snippet can identify a campaign name and/or an ad group name, for instance.

B. Call Flows

Implementations can employ “call flows,” which are user-defined treatments to be applied to calls. Call flows take dynamically provisioned phone numbers and give them call treatments.

As part of a call treatments, users can specify the type of data to be gathered. Various types of data can be suggested or provided so that the user can browse or select the data to be gathered. Flags for different data can be turned on or off, depending if that data is to be gathered. These flags can be fixed for all callers of a subscribing company (user), or they can be dependent on certain factors, e.g., if a user is a new caller then certain data can be obtained, and when the user is an existing one, certain data may not be gathered during the call.

If a user subscribes to a service for gathering data (e.g., as certain data gathering techniques can be subscribed to or not in the system), the user can be provided tags of data that can be retrieved the transient data store and used to gather more data or that can be sent to an external system. The data store can store metadata for a user as to what services are turned on and turned off.

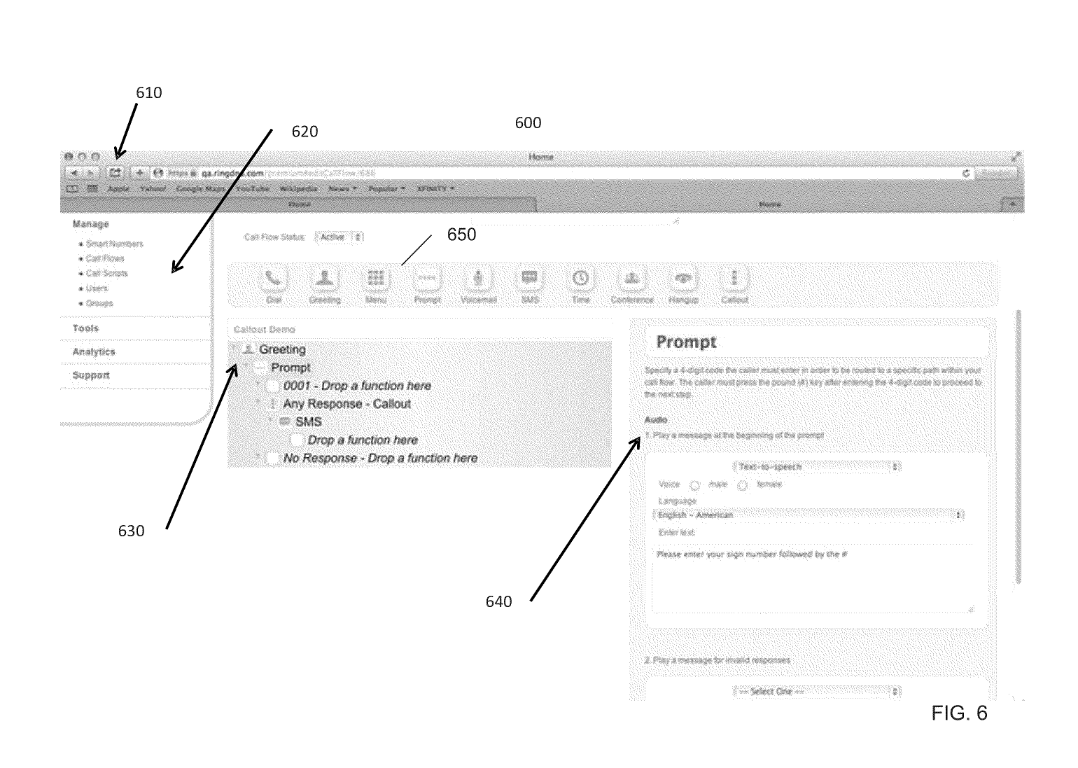

FIG. 6 is a diagram of a user interface 600 for call flow campaign tracking according to embodiments of the present invention. In the example shown in 600, the user sets up a call flow from a browser 610. Navigation options are displayed in area 620. In area 630, the user can easily set up the call flow functions using drag and drop functionality. In area 640, the user can edit the prompt that will be displayed as part of the call flow set up in area 630.

Menu 650 also a user to specify different parts of the call flow process. As shown, a user can specify a greeting, e.g., an automated greeting. A menu can be provided for the user to selection an option for directing the call. A prompt can be provided for directing the call, for which the page is shown in FIG. 6. Other options include sending a text message to the user. A key part of the call flow is a callout, which is described next.

Area 630 can be used to select various options, e.g., a greeting and prompts. Menu 650 can be used to select a type of function (e.g., a callout). A user can drag and drop any item from menu 650 into area 630 to add the function to the call flow, e.g., in association with a particular prompt to the user.

C. Integration with External Providers (Call Outs)

In some embodiments, the GUI can allow users to define how data is communicated between the system and an external system of an external provider. This functionality is labeled a “callout.” For instance, a customer may be prompted to enter his account number for the phone call, and the account number can be saved in the transient data store and sent to an external provider that stores information cross-referenced with the account number. Data associated with the account number can be sent back to the routing system, per defined rules of the callout. Callouts may be deployed during a call to gather data in the background of the call.

To create a callout within the UI, the user defines the characteristics of a prompt step. The prompt step is a step in a call flow which prompts the caller to perform some action, and in response implementations perform a data query to an external database and receive response data. To define the characteristics of the prompt step, the user enters data into fields shown by the UI associated with a function activation trigger, a function call to be sent to the external database, the inputs to send to the external database, and a save output.

For example, the user may direct that the callout function will be triggered when the caller enters any response after a prompt for information is played to the caller. The user may also define a function call that tells the external database what is being requested, the inputs of what data is will be sent to the external database, and what exactly should be done with the data that is received from the external database in response to the callout (e.g. save the data to the transient data store).

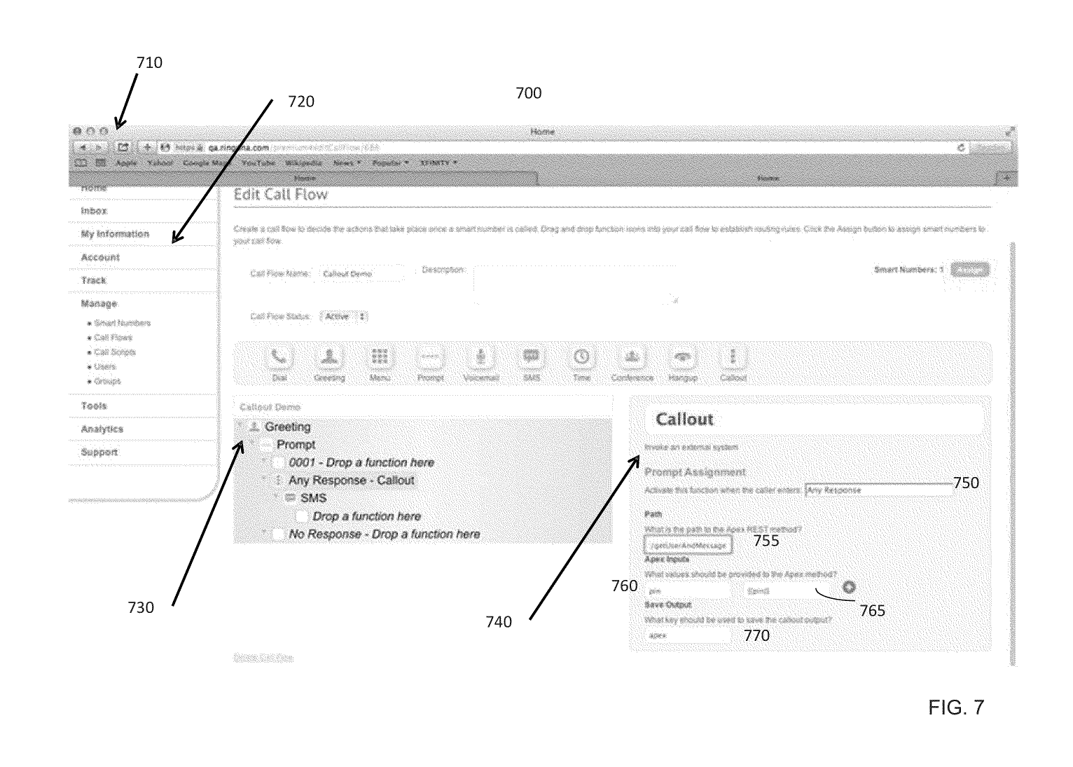

FIG. 7 is a diagram of a user interface 700 for call flow callouts according to embodiments of the present invention. In the example shown in 700, a call flow editing screen is displayed in a web browser window 710. The user can navigate among implementation options in area 720, and set a callout in area 730 using drag and drop functionality. In area 740, the user can edit the callout. User interface 700 can be used to define how data is to be communicated between the call processing system and an external provider.

In the display shown in user interface 700, the user has typed “Any Response” into the function activation trigger field 750 (an example of an input object), which means that any response by the caller after a prompt for information will trigger the callout function. However, in other embodiments, only certain responses by the user will trigger the call out.

Path field 755 is another example of an input object. In various embodiments, the path can correspond to a particular external system (e.g., a URL or other destination address); a particular port, function, or address of the external system, or to a function call in a widget on the system that knows a destination address. As shown, the user has specified “:/getUserAndMessage” to be used in sending the message. Different paths can correspond to different functions for the external system to perform.

Inputs can be provided to the path provided, where the inputs are part of a message that is sent to the external system. If the path is a function, the function can send the message to an appropriate destination address, e.g., as specified in widget logic. Field 760 allows a user to specify a first key for specifying how data is stored in the transient data store. The user has input “pin” into an input field, meaning the caller's pin number will be submitted to the external database. The field 765 allows a user to specify a second key for how data is stored at the external system.

The external system can respond to the message with response data. Field 770 allows a user to specify the key for saving the response data in the transient data store. As shown, the user has input “apex” into the save output field, which means that an apex key will be used to save the callout output.

Implementations may also have a UI that allows the user to choose from a list of data sources in requesting data via a callout. This makes it easier for the user to define what the external data sources are. Users can also use an outside API that can retrieve any data that's contextual to them, and prioritize it in a way that is relevant for their representatives.

Callouts may also be used to route calls to the best representative for a given call. For example, the user may input data about the call, e.g. campaign information associated with the dynamically provisioned phone number that was dialed, specific search terms used, what selections were made on a web page, etc. The external database can return the phone number of the representative best fit to handle the call, and implementations then route the call to that phone number.

A callout can thus allow a user to specify how a piece of data (identified via a key used to store in the transient data store) maps to data at an external system. Multiple callouts can be created, each of which can happen at a same caller response or at different caller responses. A callout can also be triggered by other actions, such as a response from a previous callout. For example, logic can analyze the response data and send another message based on what the response data is for the first callout.

In one embodiment, the message can send all or a large portion of the transient data store in one message. This can be done by specifying the corresponding keys for the data to be sent and the corresponding keys for how data is stored.

D. GUI Method

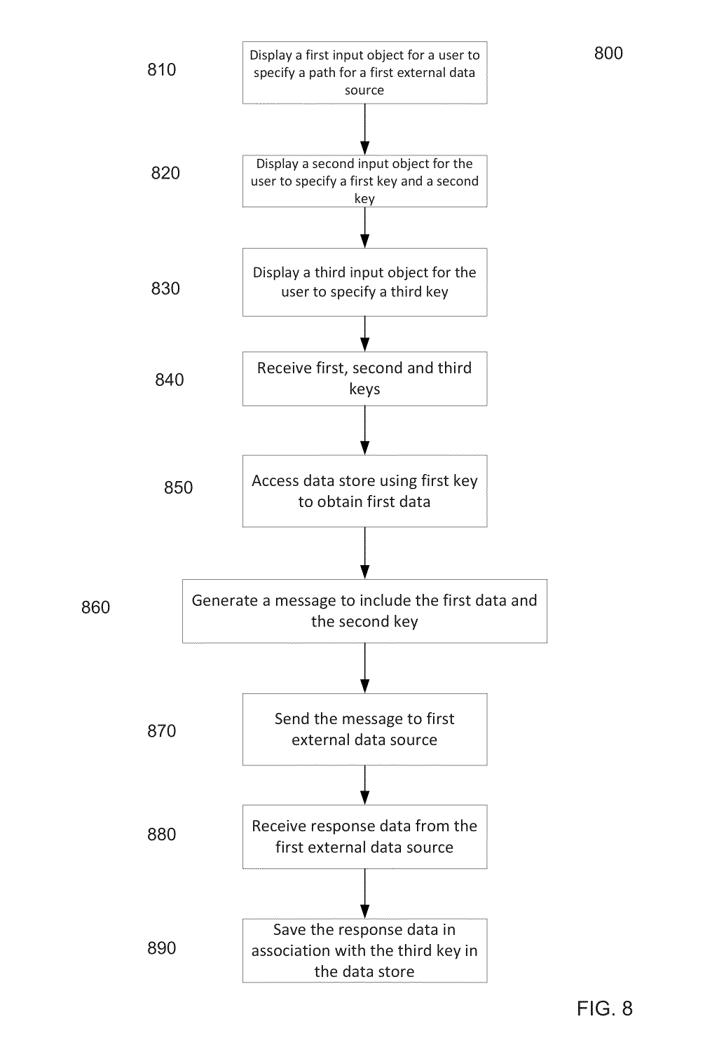

FIG. 8 is a flowchart of a method 800 for providing a graphical user interface (GUI) for specifying an interface for exchanging data between a call routing system and a first external system according to embodiments of the present invention. In one embodiment, the GUI of FIG. 7 can be used.

At block 810, a first input object is displayed for a user to specify a path for the first external system. The path is the location of the first external system from which data is sought. For example, the path may be a directory name of a CRM database that contains certain data that the user is requesting.

At block 820, a second input object is displayed for the user to specify a first key and a second key. The first key corresponds to first data stored at the call routing system; the first data is sent to the first external system in a message. The second key corresponds to how the first data is stored at the first external system, wherein the message includes the second key. The first data could be, for example, an account number or pin number entered by a caller in response to an automated message requesting such information at the beginning of the call.

At block 830, a third input object is displayed for the user to specify a third key for storing, at the call routing system, response data from the first external system. The third key defines how the response data is to be stored, for example, with which tags it should be placed in the transient data store.

At block 840, the first, second and third keys are received. This can occur after the user enters data into the input objects corresponding to all three keys.

At block 850, a data store is accessed using the first key to obtain the first data. For example, a callout can be defined to be performed based on a specified response from a user. When that user response is received, the callout can be activated. For each response, a list of responses that trigger a callout can be searched to determine if any callout is satisfied.

The activation of the callout cause the first key to be used to obtain the first data. A query can be provided to the transient data store, where the query includes the first key. Data matching the first key can be returned. If more than one piece of data is returned, each piece of data can be returned as a separate value.

At block 860, the message to include the first data and the second key is generated. This message will direct the first external system what data is being requested and how to retrieve it correctly. The message can be generated by any logic in the system, including widget logic provided by a user or logic within integration module 145.

At block 870, the message is sent to the first external system. The second key tells the first external system how the first data is stored so that it can be handled correctly to carry out the data request. For example, the first external system can use the second key to retrieve data corresponding to a particular phone number or name, which may be included in the message or a same communication session, but in a different message. The particular path in which the message was received can define the particular function that the first external system to perform and the data that is output.

At block 880, the response data from the first external system is received. The response data can be received as part of a response message. The response can be identified as part of a particular callout, which has the key for the response data defined.

At block 890, the response data in association with the third key is saved in the data store. The third key directs implementations of method 800 how the data is to be saved, e.g. in the transient data store.

### IV. Routing

When someone is calling, embodiments may route the call to the representative with the best value for the caller and representative company, based on the caller's profile and representative's profile. Examples are described below.

A. Method

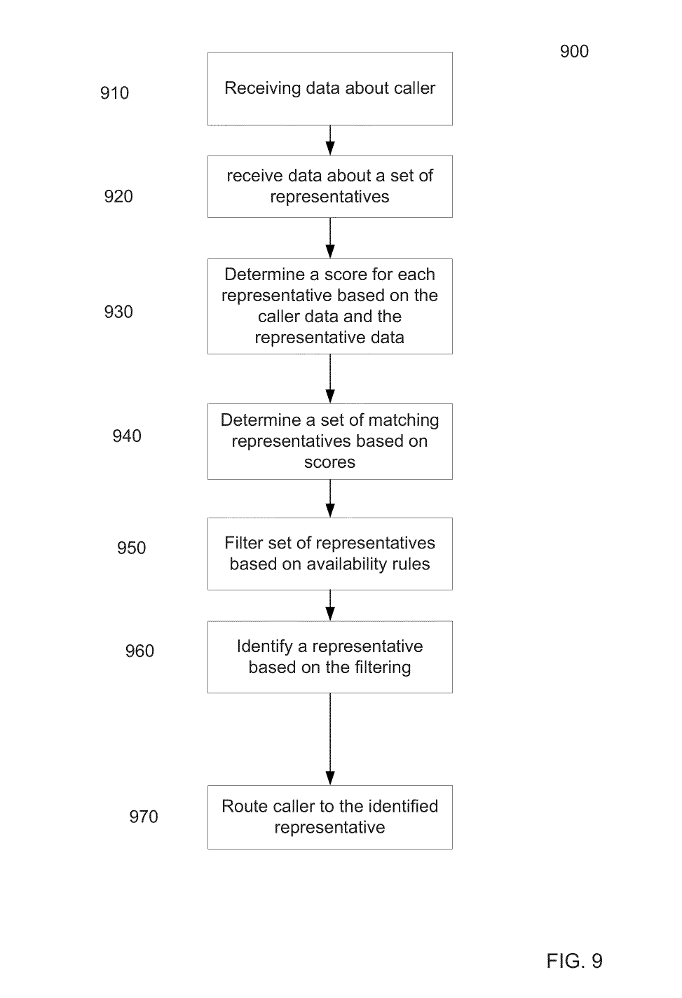

FIG. 9 is a flowchart of a method 900 for routing an incoming call according to embodiments of the present invention. This method is generally used to route an incoming call to an available representative who is the best suited to receive the call, based on a user-defined analysis of certain factors.

At block 910, data is received about a caller. This data may come from internal and/or external databases, and may include, but is not limited to, caller identification details, the customer's previous call history, current location, internet cookie information, calling device's MAC (media access control) address, the number that was dialed by the caller, caller account information, social media data, etc. Refer to section II for information regarding data gathering processes.

For example, data received about a caller may indicate that her name is Shirley, she lives in upstate New York, she dialed a dynamically provisioned phone number that appears on web pages for printer comparisons, and four years previous to the current call she bought a printer from a sales representative whose name is Frank and whose phone number is 555-453-9672.

All of the individual pieces can be mapped to an individual phone number so that it can be known that the call is attached to a campaign source. Based on the campaign, it can be known that the person is on the website looking at the support page (or other page), and the system can know the keyword they typed to get to the page. This data can be used in routing.

At block 920, data is received about a set of representatives. Typically the representatives will have an association with the user of method 900, so that the representatives may receive calls routed using method 900; the association is typically that they work for the same company. Data about the representatives may come from internal and/or external databases, and may include, but is not limited to, name, geographic location, area(s) of expertise, level of experience, performance statistics, etc.

For example, the data for a representative may indicate that his name is Bob, his phone number is 555-373-1441, he works from an office in San Francisco and is in charge of sales for networking products for northern California, and has a high closing rate for calls that originate from dynamically provisioned phone numbers that appear on websites that have been reached via the search terms “enterprise networking” and “enterprise networking solutions.”

At block 930, a score for each representative is determined based on the caller data and the representative data. This determination is made by a routing engine that uses predefined call treatments set by the user. These call treatments assign certain values to the caller data and representative data in order to make routing determinations. Examples of scoring dependencies may include, but are not limited to, the skills of sales representatives, the marketing channel that led to the call, and the geographic location of the originating call.

As an example, the user assigns numerical values to the dynamically provisioned phone numbers assigned to a certain marketing campaign; in this case the user chooses to assign a high value to the phone numbers that appear on web pages that indicate the caller may be far along in the buying cycle, and a lower value to those that indicate the caller is at the beginning of the buying cycle.

The user can include these numerical values, as well as numbers that may correspond representatives' experience (e.g. the length of time they have been doing the job, and their closing rates) in a call treatment aimed to route callers who may be far along in the buying cycle to the most seasoned representative, with the hopes that these representatives have the greatest opportunity to close these types of deals. Call treatment logic could follow many other forms, for instance they can route calls based on whether a product is in a discount or a luxury category, or by the type of product, e.g. a printer vs. a hard drive, etc. The various numerical values can be weighted depending on importance and summed to provide the score.

At block 940, a set of matching representatives is determined based on the scores. Typically, the set of matching representatives will be those who received the most desirable score based on the call treatment defined by the user. This set can include one or more representatives, for instance the top ten-scoring representatives may be determined. This can be fuzzy logic provides the list of who the best matches are for this call. In various embodiments, the matching representatives can be any rep above a threshold score, the top score, or N highest scores.

For example, suppose a customer just bought a new television. The caller can be routed representative with specific knowledge of the television. As another example, if the CEO of an important customer company calls, the call can be transferred to a proper representative. In one example, if the caller was already a customer in the database, the call be routed to a sales rep that already has a relationship with the customer, which can be defined by who is assigned to the person in a database of an external provider that manages CRM.

At block 950, the set of representatives is filtered based on availability rules. Implementations can determine whether a representative is available to receive the call, based on whether they are online or offline, or currently on another call. Availability rules can be defined by the user. For example, the user could set the rule such that the top-scoring representative determined at block 940 is always routed the call, regardless of whether that representative is available or not. Or, the rule could be set so that unavailable representatives are filtered out of the available pool of representatives that the call me be routed to. The availability rules can also include how many leads do they have versus somebody else for redistribution.

These rules can be set with certain conditions, for instance depending on the type of product, marketing campaign, caller identity, representative experience, etc. For example, Bill may be the only representative who is knowledgeable about enterprise routers; if the data received in block 910 indicates the caller is calling for information about enterprise routers, the user could set an availability rule to say that if the subject of the call is going to be about that enterprise routers, then do not filter by availability (and a call treatment could be set such that Bill would always score the highest when the subject of the call was about that product): this would ensure that the call would be routed to Bill or his voicemail, regardless of whether he was available or not.

At block 960, a representative is identified based on the filtering. The availability rules can be applied against the set of representatives determined in 940 to identify the representative who should be routed the call.

At block 970, the caller is routed to the representative identified at block 960. In one embodiment, the call can be routed to any device of the selected representative. The routing can provide data associated with the caller. Voice and data can be provided to any number of devices associated with the selected rep. Control elements can also be provided to the rep for controlling the call, e.g., to transfer the call.

B. Examples

Embodiments can determine how to route based on matching skills of the rep with the customer. For example, sales data can be tracked for reps for a given provisioned number, and the reps that perform well with that provisioned number can be given a higher score. As another example, a campaign might have some certain properties or certain categories, and reps have been tracked on performance for the properties or categories (e.g., discount or luxury). A conversion rate of turning a call into a sale can be used to determine performance.

In another example, a customer typed in “printer” into a search engine, which indicates that the person is in a very early stage person in the buying cycle, which can be handled by a junior rep whose time is less valuable than an experience rep. If it is somebody who is actually on a page that's comparing printers, that is someone who is further down the funnel and therefore should get a more seasoned rep.

V. Control with Multiple Devices

A. Separation of Voice and Data

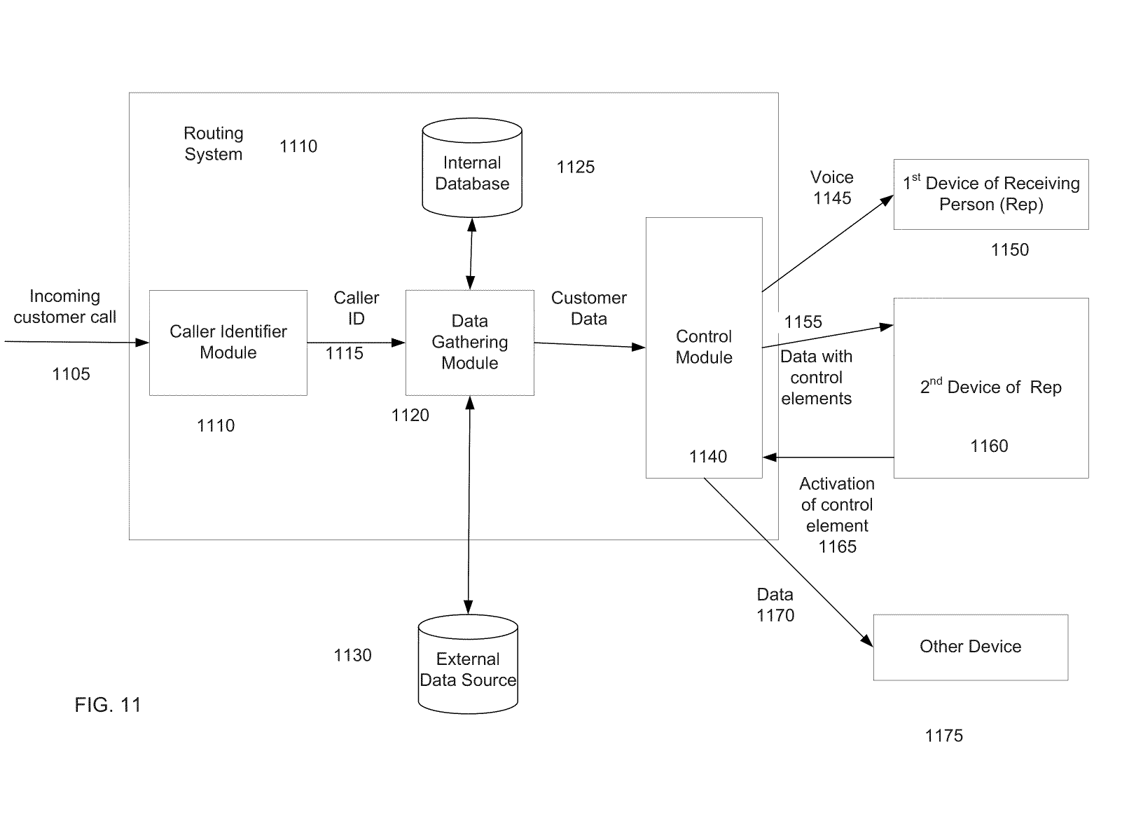

FIG. 11 is a diagram of a system 1100 for separation of voice and data elements of a call according to embodiments of the present invention. System 1100 allows a representative to take the voice element of a call a first device, the data element on a second device, and control the call (e.g. mute, transfer, retrieve and display certain data) across all devices that are handling the call.

An incoming customer call 1105 is received by routing system 1100. A caller identifier module 1110 can gather caller identification data 1115 related to the incoming call and delivers it to a data gathering module 1120. Data gathering module 1120 can also receive data from an internal database 1125 and from one or more external data sources 1130. Refer to sections I and II for more details on receiving incoming calls and data gathering, respectively.

Customer data 1135, which contains all data related to an incoming call (i.e. caller ID 1115 and data from internal database 1125 and external data sources 1130), is sent to a control module 1140. Control module 1140 is responsible for directing the traffic of a voice element 1145, and data and control elements 1155 related to a call.

Control module 1140 can send a voice component 1145 of incoming customer call 1115 to a first device 1150 of a receiving person (e.g. call representative). The result is that the receiving person can hear the audio related to the call on first device 1150. Voice element 1145 can also automatically be sent to this or other destinations by bypassing control module 1140, if desired.

Control module 1140 can send data with control elements 1155 to a second device 1160 of a receiving person (typically the same person/representative who possesses first device 1150). This allows the representative to see the data elements of the call, e.g. data from a CRM system that details the buying history of the caller, right on the screen of second device 1160, while simultaneously hearing voice element 1145 on first device 1150. This gives the representative a more complete picture of who the caller is and why they are calling, so that better service can be rendered.

The control elements allow the representative to control the call. Control elements may include, for example, the ability to mute, transfer, or end the call; these control elements may be displayed to the representative using a GUI that is displayed on second device 1160. Control elements also can include the functionality that allows the representative to create callouts and call flows (discussed in section III) from the second device or other devices and consume the data output across the devices that have been granted a control channel.

If the representative activates a control element 1065, instructions are sent from second device 1160 to control module 1140. Control module 1140 responds by sending the control instructions to the appropriate destination, which may be first device 1150, second device 1160, or another device 1175.

For example, the representative activates the control element on his tablet (here, second device 1160) to display data with control elements 1155 on his computer screen (here, another device 1175). Control module 1140 sends a data 1170 to the computer so that it may display, for example, CRM details related to the caller on the computer screen (in addition to the tablet).

The architecture of system 1100 allows users to use the voice provider of their choice, without sacrificing the data and control over the call that is provided by system 1100. The call can come in on the user's phone, which is serviced by their chosen voice provider, and the user can define which of his other devices he wants the data to be sent to, for example his laptop computer via a web browser, his tablet, a trainee's tablet, etc. Any device that the user registers with system 1100 can act as a controlling device and gets its own controlling channel so that it may interact with control module 1140 (i.e. it can be sent data with control elements 1155 and activate control elements 1165).

B. Central Control

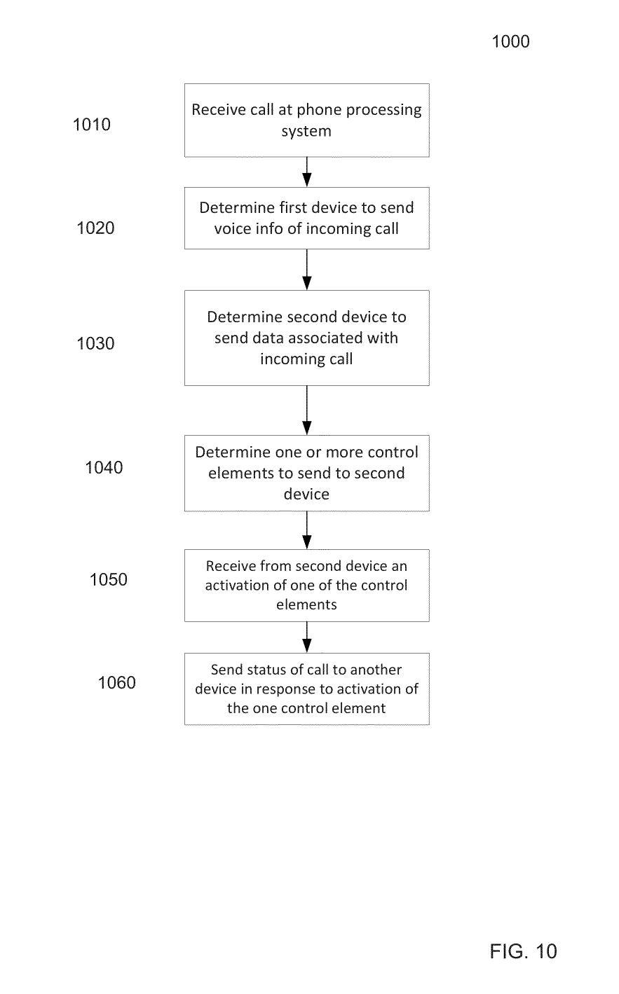

FIG. 10 is a flowchart of a method 1000 for providing centralized control for processing incoming calls according to embodiments of the present invention.

At block 1010, a call is received at a phone processing system. See section I-A for further information on receiving a call.

At block 1020, a control module of the phone processing system determines a first device to send voice information of the incoming call via a voice channel. This determination may be done based on a default setting defined by implementations of method 1000, or may be defined by users. For example, the user can direct the control module to send voice information to the user's cell phone, office phone, tablet, or other device. This determination can be sent to the voice provider, and the voice provider can send the voice data directly to the device.

At block 1030, the control module determines a second device to send data associated with the incoming call via a data channel. This determination can be based on either default settings of implementations of method 1000, or may be defined by users. The first and second devices can be the same or different.

Any device that the user registers with implementations of method 1000 can receive data via a data channel. A default setting, then, may direct the control module to send data to the second device that is registered (where the first device is registered to receive voice data). Or, the default setting could direct the control module to send data to a registered device that has the strongest wireless network connection. Users can define their own rules as well; for example, a user could create a rule that directs the control module to always send data to the user's tablet.

At block 1040, the control module determines one or more control elements to send to the second device via a control channel. In various embodiments, this can be determined by the administrator of implementations of method 1000, or by the user. The control module can determine which control elements should be sent to the second device via the control channel. A control element can be sent to multiple devices. As examples, the control module can send the following control elements to the second device: mute, transfer, and end call.

Control elements allow the representative to control the call. Control elements may include, for example, the ability to mute, transfer, or end the call; these control elements may be displayed to the representative using a GUI that is displayed on the second device. Control elements also can include the functionality that allows the representative to create callouts and call flows (discussed in section III) from the second device or other devices and consume the data output across the devices that have been granted a control channel.

At block 1050, an activation of one of the control elements is received from the second device. For example, the user activates a control element to mute the call by triggering an object on the screen corresponding to that action, through a mouse click, touch on a touchscreen, etc. This action is sent from the second device back to implementations of method 1000.

At block 1060, information about the call (e.g., indicating a status of the call) is sent to another device in response to receiving the activation of the one control element. In the example above of the user activating the control element to mute the call, that action is received by implementations of method 1000, and in response, the information is sent to another device. For example, the message can provide a status to the other device about devices connected to the call or devices that are muted.

In-call control elements can be distributed across devices, shared, and used simultaneously. For example, a call can be received on a mobile phone and the voice info is delivered to it. A tablet can receive the data and have a control channel for activating the control elements, so that activating the mute function on the tablet could mute both the tablet and the phone, or just the phone. The tablet could also be used to transfer the call.

Different devices that have control channels for activating control elements may have access to different control elements. For example, one tablet may only be able to mute the call, while another tablet can mute and transfer the call.

The backend system of implementations of method 1000 can be cloud-based, which enables the users to access implementations from many locations on different devices. For example, a user can access implementations from a computer using implementations' browser extension that turns the browser into a phone (refer to section V-D for further information). Or, the user can access implementations on their tablet using implementations' functionality that turns the tablet into a phone. Or the user can access implementations on their phone using software applications that implement method 1000.

C. Examples of Central Control

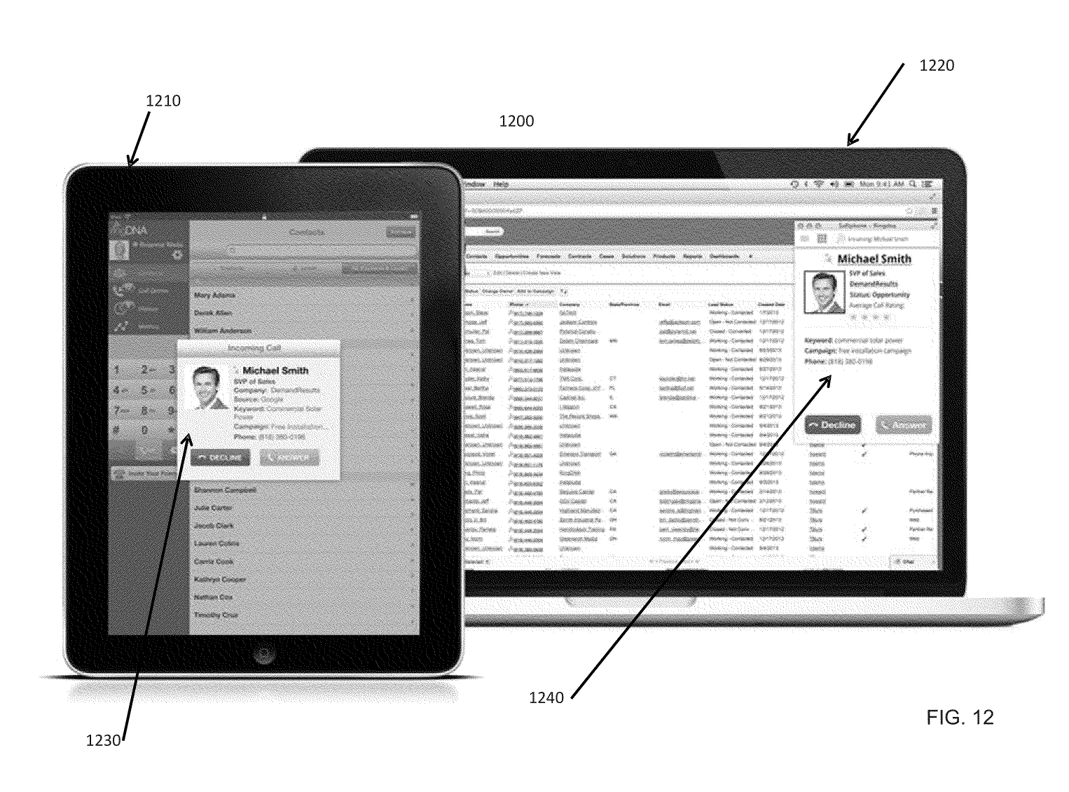

FIG. 12 is a diagram of a user interface 1200 for providing centralized control of an incoming call according to embodiments of the present invention.

In FIG. 12, a user (such as a call agent) has implementations running on both a tablet 1210 and a laptop computer 1220. These devices have been registered with implementations so that they may receive data through a data channel and receive control elements and send control instructions through a control channel. Window 1240 shows an application that can communicate with a control server or module.

When an incoming call is routed to the user, the user may receive notifications on any or all devices they have registered to handle data and control. In user interface 1200, a notification window 1230 is displayed on tablet 1210, and a notification window 1240 is displayed on laptop computer 1220. Both notification windows 1230 and 1240 show certain details about the caller, e.g. name, title, company, call source, keyword associated with the dynamically provisioned phone number that the caller dialed, the associated campaign, and phone number. Implementations can show more or less information than is displayed in example user interface 1200.

Also shown are decline call and answer call buttons in both notification windows 1230 and 1240. If the answer button in notification window 1230 is pressed, call data can be sent to tablet 1210 so that the user can use the tablet for the call, and the call is ignored on laptop computer 1220 and notification window 1240 closes. In the alternative, the answer button in notification window 1240 may be pressed, in which case the call data can be sent to laptop computer 1220 so that the user may it to handle the incoming call; the call is ignored on tablet 1210 and notification window 1230 closes. In another scenario, the decline button is selected in either notification window 1230 or 1240, which would cause both devices 1210 and 1220 to ignore the call, and both notification windows 1230 and 1240 would close.

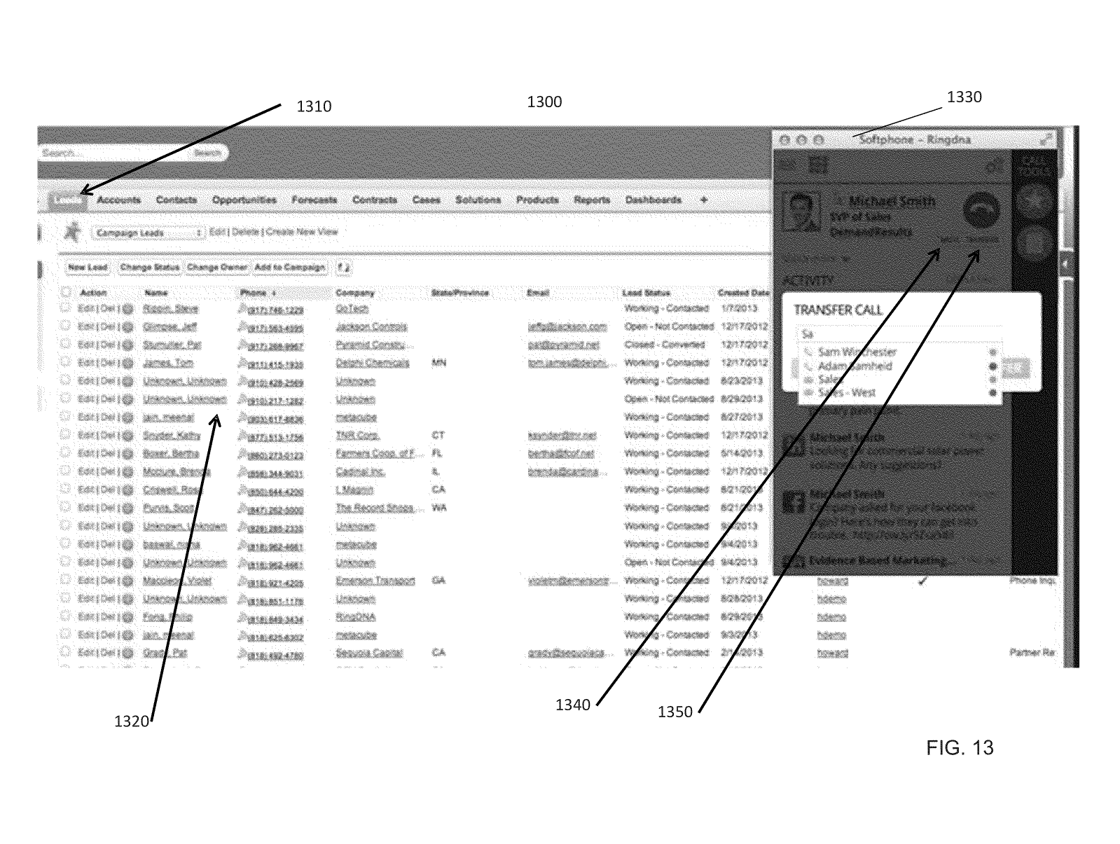

FIG. 13 is a diagram of a user interface 1300 for providing centralized control over the transfer of a call according to embodiments of the present invention.

User interface 1300 displays information to the user on a computer screen via a web browser. The user may select options from a navigation toolbar 1310. In this example, an option for “leads” is selected, which causes area 1320 to populate with content related to leads, e.g. names, phone numbers, companies, states, emails, lead status, etc. These fields may be edited or deleted from user interface 1300.

Area 1330 shows a window with information related to a phone call that is controlled by the web browser. In this example, a mute control element 1340 and a transfer control element 1350 are displayed in area 1330. The user has selected transfer control element 1350, causing area 1330 to darken and to display a transfer call window, in which the user can select a destination to transfer the call to. The list auto-populates from an internal or external database as the user types. For example, if a CRM system is linked to implementations, the CRM username could be entered into the window, and the corresponding phone number could be used as the destination for the transfer.

To transfer the call, the user can enter or select a name, and click the transfer button. This action can cause a message to be sent to the control module indicating that the call should be transferred, and the control module can then transfer the call to the desired destination.

D. Integration of Device with Server (Plug-in)

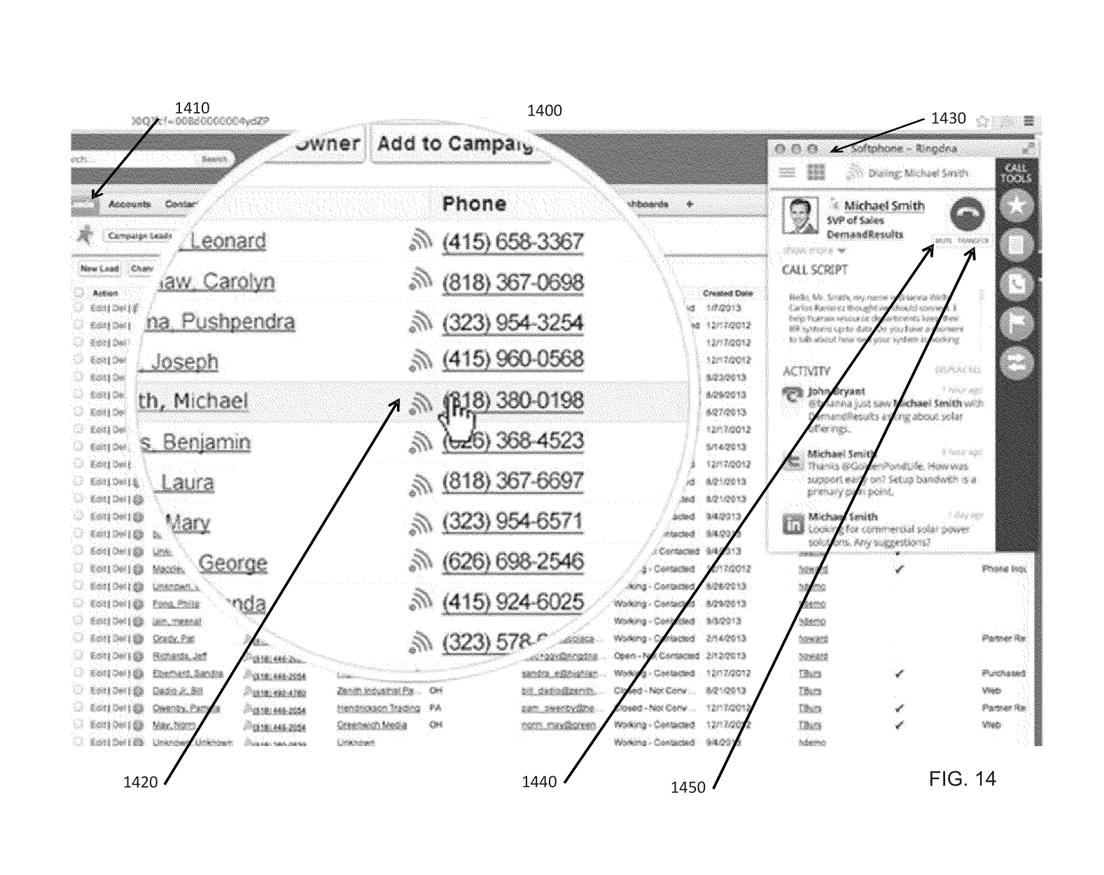

FIG. 14 is a diagram of a user interface 1400 for providing centralized control of an outgoing call according to embodiments of the present invention. User interface can include a browser that interacts with a plug-in that is in communication with a centralized control. The plug-in can allow data from the browser to be sent to the control server and used in making an outgoing call. In this manner, the browser can be used to access systems described herein.

User interface 1400 displays information to the user on a computer screen via a web browser. The user may select options from a navigation toolbar 1410. In this example, an option for “leads” is selected, which causes another area of the window to populate with content related to leads, e.g. names, phone numbers, companies, states, emails, lead status, etc. These fields may be edited or deleted from user interface 1400.

Area 1420 is a magnified sample of the list of leads shown in user interface 1400, that shows names and phone numbers. The user can select a phone number from the list, which causes a call to that phone number to be initiated, and for a window 1430 to be displayed on the screen that contains details about the call. In the sample shown in user interface 1400, the destination of the call is to Michael Smith, SVP of Sales at DemandResults, a call script is displayed for the user to follow, and social media details related to Michael Smith are also shown.

The phone number can be communicated to the plug-in browser extension, which can send the number to a phone processing system (e.g., a server that is on the Internet). The system can then initiate a phone call. And, the plug-in can receive data that is communicated to the browser to open a window 1430 to facilitate the phone call.

Window 1430 also contains a mute control element 1440 and a transfer control element 1350. Thus, on outbound calls, users can use control elements to perform actions via implementations' control module. For example, the user could call Michael Smith, and during the call, use transfer control element 1450 to transfer the call to another agent for Michael Smith to speak to.

Users can define custom widgets to retrieve specific data from implementations internal databases, as well as from external databases. For example, a user might be interested in seeing information from a specific financial provider that is related to the caller or to the receiver of an outbound call. Implementations are designed such that these widgets can run on top of implementations' own logic, which allows for customized experiences for the user. Widget UI can be similar to the UI shown in FIGS. 5-7 for creating call flows and callouts.

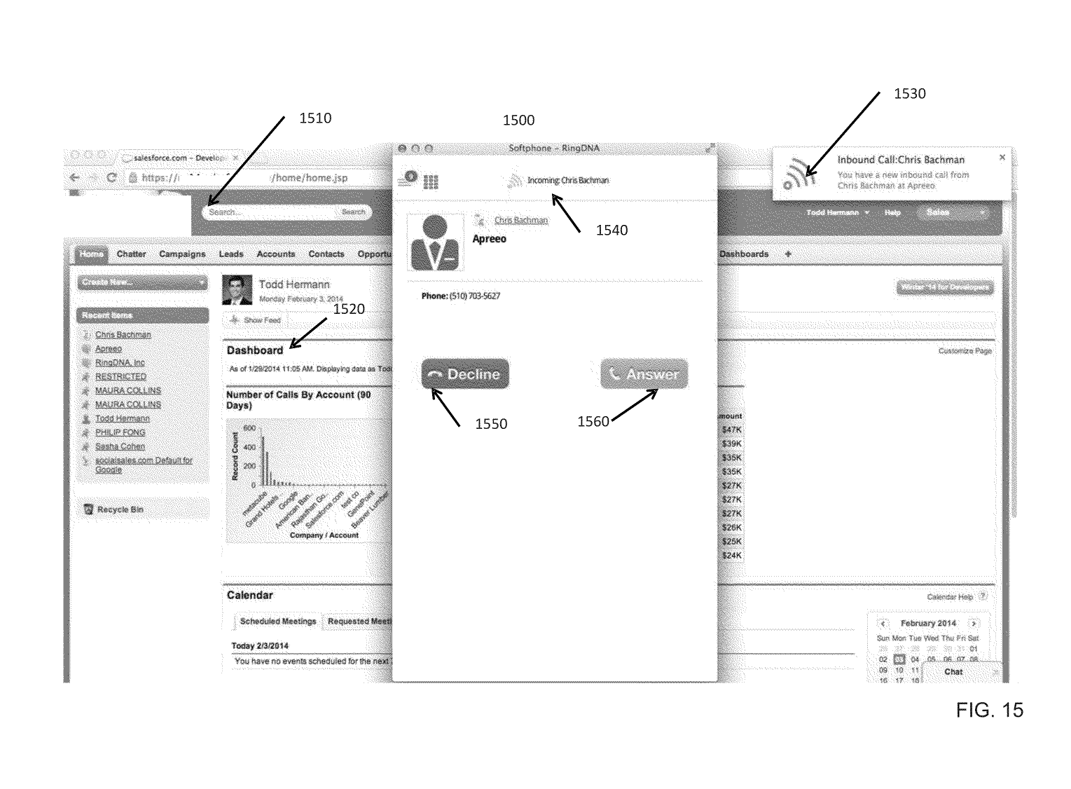

FIG. 15 is a diagram of a user interface 1500 for integrating a device with a server using a plug-in according to embodiments of the present invention. User interface 1500 displays information to the user on a computer screen via a web browser 1510. The information displayed is a CRM dashboard whose database is in communication with the Web browser, which is in communication with the plug-in that is in communication with a phone processing system.

Area 1530 shows a notification that the user is receiving an inbound call, in this case from “Chris Bachman at Apreeo.” This is made possible by the plug-in browser extension that communicates with the browser. The plug-in can receive the phone call from the phone processing system, and display an alert 1530 as well as window 1540. The data can be sent to the browser via the browser extension, which enables the browser itself to become a phone-like device that can transmit and receive voice, data, and control elements.

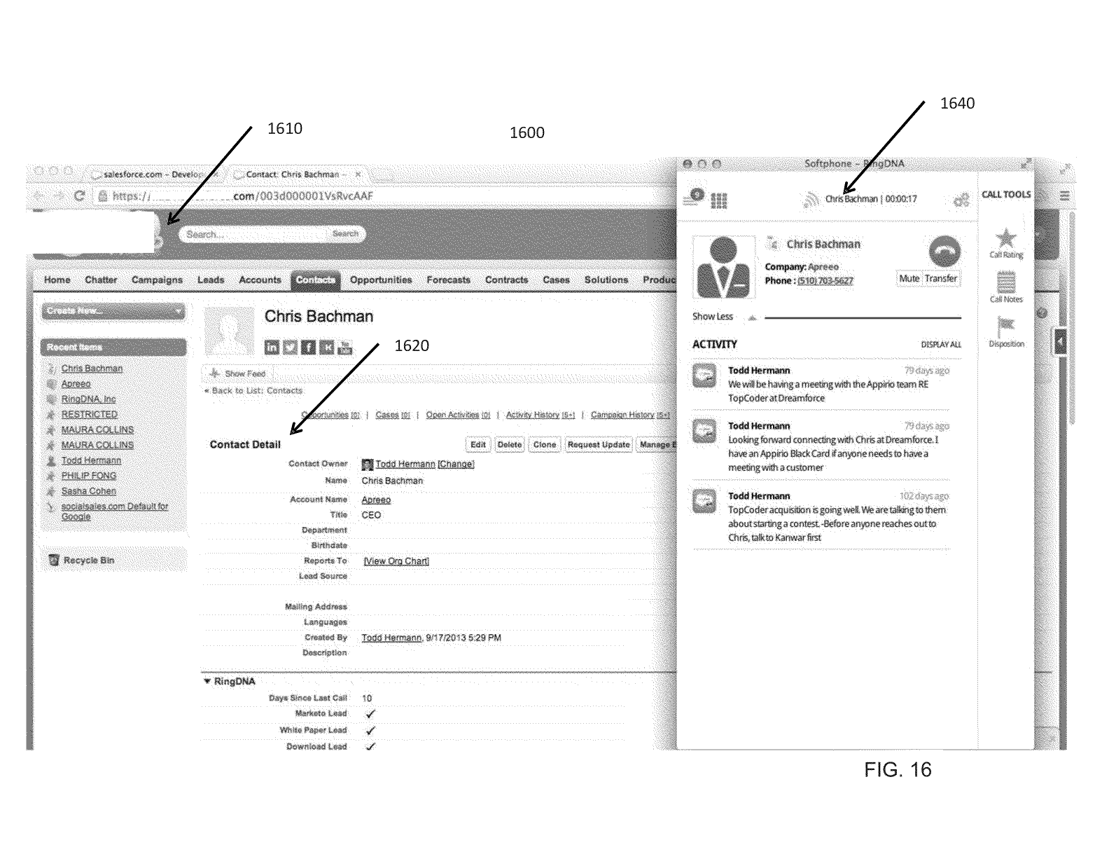

Area 1540 shows further details related to the incoming call, and provides options of whether to decline or to answer the call by selecting a decline button 1550 or an answer button 1560. Area 1540 can be shown as soon as the inbound call is received, or after the user clicks area 1530. If the user selects answer button 1560, the call can be accepted, and can cause user interface 1600, shown in FIG. 16, to be displayed to the user.

FIG. 16 is a diagram of a user interface 1600 for integrating a device with a server using a plug-in according to embodiments of the present invention. User interface shows how the plug-in extension can communicate with the phone processing system to instruct a browser to change a page. FIG. 16 shows a change in the browser as a result of answering the call in FIG. 15.

User interface 1600 displays information to the user on a computer screen via a web browser 1610. In FIG. 16, the information displayed is a CRM dashboard of a database service that is being accessed by the browser. Because the CRM database is being access by the browser, which is in communication with the plug-in and since the user has accepted the incoming call from a caller identified as Chris Bachman, the page 1620 has changed.

The plug-in can communicate with the phone processing system and receive data about the incoming caller. The plug-in can user the contact information to send a request to the CRM database, via the browser. The request can indicate a particular page to which the browser should navigate. For example, the plug-in can be programmed to perform a query to the CRM database to display the page (e.g., a contacts page) related to the caller. Thus, the browser can access the CRM database based on a user's preferences or selections to show contact details 1620 that exist in the CRM database that are associated with Chris Bachman.

Additionally, window 1640 can be displayed on the screen that contains details about the call; in the sample shown in user interface 1600, the caller's name, company, phone number, and social media activity is displayed. Window 1640 also contains a mute control element and a transfer control element, allowing the user to mute or transfer the call from the web browser and send out corresponding directions to other devices via the control module.

The browser extension enables users to access implementations from any computer which has an internet connection and a web browser that supports the browser extension. And because the browser is able to get its own control channel, the central control functions discussed in section V-A and V-B can be implemented from the browser, or can be implemented at the browser from other devices. For example, an incoming call could be transferred from a user's tablet to their web browser.

Consider the following scenario that can be made possible using the browser extension, paired with central control and data gathering tied to external databases. A phone call is received by an agent, and the voice portion is delivered to the agent's desk phone. At the same time, the agent's tablet displays the data portion of the call, which includes details about the caller that have been gathered from the user's CRM account which already contains details about the caller. Because the CRM service is notified that a call has been received from someone in the user's account, the CRM service automatically opens to the contact detail page in the user's web browser via the browser extension.

### VI. Computer System

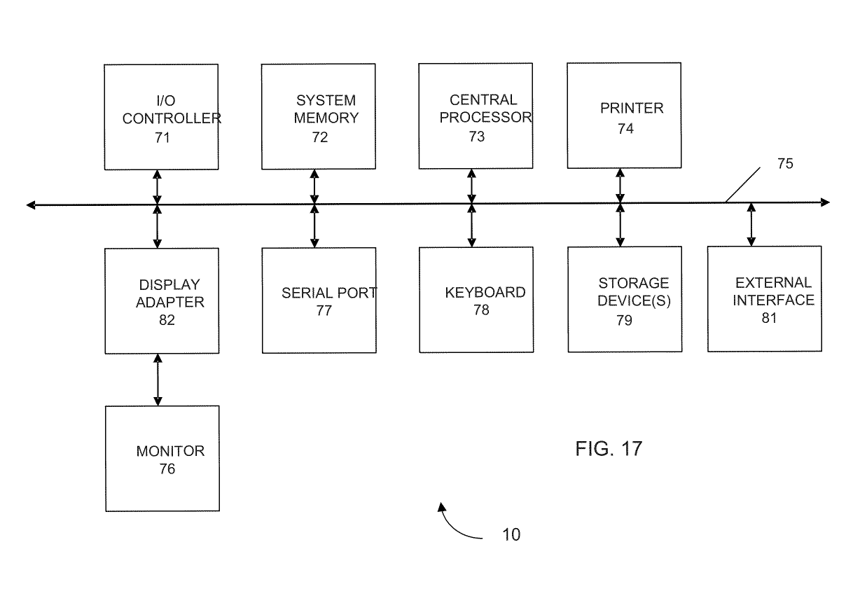

Any of the computer systems mentioned herein may utilize any suitable number of subsystems. Examples of such subsystems are shown in FIG. 17 in computer apparatus 10. In some embodiments, a computer system includes a single computer apparatus, where the subsystems can be the components of the computer apparatus. In other embodiments, a computer system can include multiple computer apparatuses, each being a subsystem, with internal components.

The subsystems shown in FIG. 17 are interconnected via a system bus 75. Additional subsystems such as a printer 74, keyboard 78, storage device(s) 79, monitor 76, which is coupled to display adapter 82, and others are shown. Peripherals and input/output (I/O) devices, which couple to I/O controller 71, can be connected to the computer system by any number of means known in the art, such as serial port 77. For example, serial port 77 or external interface 81 (e.g. Ethernet, Wi-Fi, etc.) can be used to connect computer system 10 to a wide area network such as the Internet, a mouse input device, or a scanner. The interconnection via system bus 75 allows the central processor 73 to communicate with each subsystem and to control the execution of instructions from system memory 72 or the storage device(s) 79 (e.g., a fixed disk, such as a hard drive or optical disk), as well as the exchange of information between subsystems. The system memory 72 and/or the storage device(s) 79 may embody a computer readable medium. Any of the data mentioned herein can be output from one component to another component and can be output to the user.

A computer system can include a plurality of the same components or subsystems, e.g., connected together by external interface 81 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g. an application specific integrated circuit or field programmable gate array) and/or using computer software with a generally programmable processor in a modular or integrated manner. As user herein, a processor includes a multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C# or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary.

All patents, patent applications, publications, and descriptions mentioned here are incorporated by reference in their entirety for all purposes. None is admitted to be prior art.

What is claimed is:

1. A method for routing an incoming phone call from a customer to a representative, the method comprising:
receiving an incoming call at a communications module of a system;
creating a call ID for the incoming call;
adding, to a transient data store of the system, a first entry corresponding to the call ID of the incoming call;
gathering data from one or more data sources according to one or more data gathering rules;
storing, in the transient data store, the gathered data in the entry corresponding to the call ID, wherein the gathered data is stored with keys identifying different pieces of data;
sending, from the transient data store to a first external system, a message including:
first data of the first entry according to a call out rule that specifies a first key corresponding to the first data, wherein the first data is stored in the transient data store associated with the first key; and
a second key that is associated with the first data at the first external system;
receiving, from the first external system, response data in response to the message; and
using the response data in routing the incoming phone call to a device of a representative.

2. The method of claim 1, wherein the response data specifies the representative to route the data.

3. The method of claim 1, wherein the response data is sent to the device of the representative.

4. The method of claim 1, wherein the first data specifies a phone number called by the customer.

5. The method of claim 1, further comprising:
saving the response data in the transient data store using a third key.

6. A computer product comprising a computer readable medium storing a plurality of instructions for controlling a processor to perform an operation of method 1.

7. A method of providing a graphical user interface (GUI) for specifying an interface for exchanging data between a call routing system and a first external data source, the method comprising:
displaying a first input object for a user to specify a path for the first external data source;
displaying a second input object for the user to specify:
a first key corresponding to first data stored at the call routing system, the first data to be sent to the first external data source in a message, and
a second key corresponding to how the first data is stored at the first external data source, wherein the message includes the second key; and
displaying a third input object for the user to specify a third key for storing, at the call routing system, response data from the first external data source.

8. The method of claim 7, further comprising:
receiving the first, second, and third keys;
accessing a data store using the first key to obtain the first data;
generating the message to include the first data and the second key;
sending the message to the first external data source;
receiving the response data from the first external data source;
saving, in the data store, the response data in association with the third key.

9. The method of claim 7, wherein the path specifies a URL.

10. The method of claim 7, wherein the path specifies a function executing on the call routing system.

11. The method of claim 7, further comprising:
displaying a fourth input object for specifying a type of response that activates sending the message.

12. The method of claim 11, further comprising:
providing a user interface for a user to provision a phone number, wherein the message is sent when the phone number is called and the response activates sending the message.

13. The method of claim 7, further comprising:
providing input objects for specifying a greeting and a prompt to be provided to a caller;
displaying one or more types of function that can be performed in response to the prompt to the caller; and
displaying a call flow such that a user can drag an icon corresponding to a type of function to schedule the function to be performed at the prompt.

14. A method of providing centralized control for processing incoming calls, the method comprising:
receiving a call at a phone processing system;
determining, with a control module of the phone processing system, a first device to send voice information of the incoming call via a voice channel;
determining, with the control module, a second device to send data associated with the incoming call via a data channel;
determining, with the control module, one or more control elements to send to the second device via a control channel;
receive, from the second device, an activation of one of the control elements;
sending information to another device in response to receiving the activation of the one control element.

15. The method of claim 14, wherein the one or more control elements includes at least one selected from mute, transfer, answer, and end call.

16. The method of claim 14, wherein the first device is the same as the second device.

17. The method of claim 14, wherein the information sent to the other device is a status of the call.

18. The method of claim 14, further comprising:
receiving, at the phone processing system, a request for an outgoing call from a plug-in that is in communication with a browser of a user computer, the request including an identification of a phone number to call;
sending, to the plug-in, data about the person whose phone number is being called, wherein a window to display the data is provided on the user device; and
connecting the user device with the phone number being called.

19. The method of claim 14, wherein the one or more control elements includes an answer element, the method further comprising:
receiving an activation of the answer element; and
sending a signal to a plug-in executing on the second device, the plug-in being in communication with a browser of the second device, wherein the signal cause the browser to change to a page that corresponds to the call.
